(19) United States
(12) Patent Application Publication
(10) Pub. No.: US 2025/0243030 A1
(43) Pub. Date: Jul. 31, 2025

(54) MEDIUM PROCESSING APPARATUS AND IMAGE FORMING SYSTEM INCORPORATING SAME

(71) Applicants: Mitsuhiro Sugawara, KANAGAWA (JP); Kei Sasaki, KANAGAWA (JP); Kazuki Seto, KANAGAWA (JP); Shohei Saito, KANAGAWA (JP); Sachika Tamaki, KANAGAWA (JP); Kohta Abe, KANAGAWA (JP); Takashi Yamamoto, KANAGAWA (JP); Nobuyoshi Suzuki, KANAGAWA (JP); Keisuke Sugiyama, KANAGAWA (JP)

(72) Inventors: Mitsuhiro Sugawara, KANAGAWA (JP); Kei Sasaki, KANAGAWA (JP); Kazuki Seto, KANAGAWA (JP); Shohei Saito, KANAGAWA (JP); Sachika Tamaki, KANAGAWA (JP); Kohta Abe, KANAGAWA (JP); Takashi Yamamoto, KANAGAWA (JP); Nobuyoshi Suzuki, KANAGAWA (JP); Keisuke Sugiyama, KANAGAWA (JP)

(73) Assignee: Ricoh Company, Ltd., Tokyo (JP)

(21) Appl. No.: 19/012,009

(22) Filed: Jan. 7, 2025

(30) Foreign Application Priority Data
Jan. 30, 2024 (JP) 2024-012157

(51) Int. Cl. B65H 37/04; B65H 43/00; G03G 15/00

(52) U.S. Cl. CPC B65H 37/04; B65H 43/00; G03G 15/6544; B65H 2301/51616; B65H 2301/5162; B65H 2551/10; B65H 2801/27; G03G 2215/00856; G03G 2215/00864

(57) ABSTRACT

A medium processing apparatus includes a liquid applier, a post-processing device, and circuitry. The liquid applier performs liquid application on a medium. The post-processing device performs a binding process on a media bundle including the medium subjected to the liquid application by the liquid applier, or a medium not subjected to the liquid application. The circuitry is to control operations of the liquid applier and the post-processing device according to operation modes. The operation modes of the post-processing device include a first mode to perform the binding process on the media bundle including the medium on which the liquid application is performed, and a second mode to perform the binding process on the medium on which the liquid application is not performed.

### CROSS-REFERENCE TO RELATED APPLICATION

This patent application is based on and claims priority pursuant to 35 U.S.C. § 119(a) to Japanese Patent Application No. 2024-012157, filed on Jan. 30, 2024, in the Japan Patent Office, the entire disclosure of which is hereby incorporated by reference herein.

### BACKGROUND

### Technical Field

Embodiments of the present disclosure relate to a medium processing apparatus and an image forming system incorporating the medium processing apparatus.

### Background Art

A medium processing apparatus that performs a process of binding sheet-shaped media in a bundle is known. Since sheets are widely known as an example of sheet-shaped media, a “sheet bundle” that is a stack of sheets is used as an example of a bundle of sheet-shaped media in the following description. Some medium processing apparatuses include a crimper that can perform so-called “crimp binding” without metal staples from a viewpoint of resource saving and reduction in environmental load. Specifically, the crimper sandwiches a sheet bundle with serrate binding teeth to press and deform the sheet bundle. There is also known an image forming system in which a medium processing apparatus and an image forming apparatus cooperate with each other, and the medium processing apparatus performs a binding process on a medium on which an image is formed by the image forming apparatus.

Since the medium processing apparatus may be used after processing in the image forming apparatus, the medium processing apparatus may be referred to as a post-processing apparatus.

A post-processing apparatus known in the art includes a liquid applying crimp binding assembly that applies liquid to a binding position of a medium bundle, and then crimps and binds the binding position using a crimp member having an uneven shape without using needles.

In addition, a different post-processing apparatus in the art including a crimp binding assembly has a technique in which a sheet separation assembly is provided in a crimper to prevent sticking of a sheet.

In a case where the sheet separation assembly of the different post-processing apparatus in the art is provided in the crimper (crimp binding assembly) of the post-processing apparatus including the liquid applying crimp binding assembly of the post-processing apparatus known in the art, there is a problem that the liquid adhering to the crimping teeth may remain, and the crimping teeth may rust.

### SUMMARY

Embodiments of the present disclosure described herein provide a novel medium processing apparatus includes a liquid applier, a post-processing device, and circuitry. The liquid applier performs liquid application on a medium. The post-processing device performs a binding process on a media bundle including the medium subjected to the liquid application by the liquid applier, or a medium not subjected to the liquid application. The circuitry is to control operations of the liquid applier and the post-processing device according to operation modes. The operation modes of the post-processing device include a first mode to perform the binding process on the media bundle including the medium on which the liquid application is performed, and a second mode to perform the binding process on the medium on which the liquid application is not performed.

Further, embodiments of the present disclosure described herein provide an image forming system including an image forming apparatus to form an image on a medium, and the above-described medium processing apparatus.

### BRIEF DESCRIPTION OF THE SEVERAL VIEWS OF THE DRAWINGS

Exemplary embodiments of this disclosure will be described in detail based on the following figures, wherein:

FIG. 1 is a view illustrating a general arrangement of an image forming system;

FIG. 2 is a view illustrating an internal configuration of a post-processing apparatus according to a first embodiment;

FIG. 3 is a schematic view of an edge binder as viewed from an upstream side in a conveyance direction;

FIG. 4 is a schematic view of a liquid applier of the edge binder of FIG. 3 in a main scanning direction;

FIGS. 5A and 5B are views illustrating an arrangement and a configuration of a second liquid storage in the post-processing apparatus;

FIG. 6 is a view illustrating an attachment and detachment configuration of the second liquid storage in the post-processing apparatus;

FIGS. 7A and 7B are schematic views illustrating a configuration of a crimper of the edge binder;

FIG. 8 is a view illustrating a modification of the edge binder;

FIGS. 9A to 9C are views illustrating a liquid application crimper according to a modification of the edge binder;

FIGS. 10A to 10C are views illustrating a liquid application process and a crimp binding process performed by the liquid application crimper of FIGS. 9A to 9C;

FIG. 11 is a schematic view of a stapling unit as viewed from an upstream side in a conveyance direction;

FIG. 12 is a schematic view of a modification of the stapling unit as viewed from the upstream side in the conveyance direction;

FIG. 13 is a hardware configuration diagram of a control block to control the post-processing apparatus according to the first embodiment;

FIG. 14 is a flowchart of a binding process performed by the edge binder;

FIGS. 15A to 15D are diagrams illustrating positions of the liquid applier and the crimper during the binding process by the edge binder;

FIG. 16 is a diagram illustrating a separation assembly according to the present embodiment;

FIG. 17 is an enlarged view of a periphery of a lower teeth-shaped portion;

FIG. 18 is a diagram illustrating a relationship with a peeling member when the lower teeth-shaped portion is located at a binding position;

FIG. 19 is a flowchart of a control process in a rust adhesion prevention mode;

FIG. 20 is a diagram illustrating an example of a setting screen for the rust adhesion prevention mode;

FIG. 21 is a diagram illustrating another example of the setting screen for the rust adhesion prevention mode;

FIG. 22 is a diagram illustrating another example of the setting screen for the rust adhesion prevention mode;

FIG. 23 is a view illustrating an internal configuration of a post-processing apparatus according to a second embodiment of the present disclosure;

FIGS. 24A to 24C are views of an internal tray according to the second embodiment in a thickness direction of a sheet;

FIG. 25 is a schematic view of a downstream side of a crimper according to the second embodiment in a conveyance direction;

FIGS. 26A and 26B are views of a liquid applier according to the second embodiment in the thickness direction of the sheet;

FIGS. 27A to 27C are cross-sectional views taken along XXV-XXV of FIG. 26A;

FIGS. 28A to 28C are cross-sectional views taken along XXVI-XXVI of FIG. 26A;

FIG. 29 is a hardware configuration diagram of a control block of the post-processing apparatus according to the second embodiment;

FIG. 30 is a flowchart of post-processing of the post-processing apparatus according to the second embodiment; and

FIG. 31 is a diagram illustrating an overall configuration of a modification of the image forming system.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. In the drawings for explaining the following embodiments, the same reference codes are allocated to elements (members or components) having the same function or shape and redundant descriptions thereof are omitted below.

A description is given of an image forming system 1 according to an embodiment of the present disclosure, with reference to the drawings.

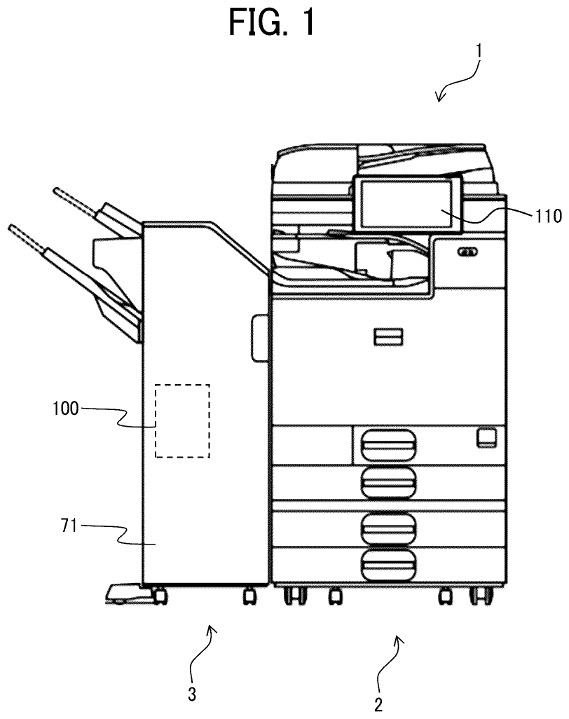

FIG. 1 is a view illustrating an overall configuration of the image forming system 1.

The image forming system 1 has a function of forming an image on a sheet-shaped medium and performing post-processing on the medium on which the image is formed. In the present specification, description will be made assuming “paper” as a representative example of the sheet-shaped medium. This medium will be described as “sheet P” as an embodiment.

As illustrated in FIG. 1, the image forming system 1 includes an image forming apparatus 2 and a post-processing apparatus 3 as an embodiment of a medium processing apparatus according to the present disclosure.

The image forming apparatus 2 forms an image on the sheet P and ejects the sheet P having the image to the post-processing apparatus 3. The image forming apparatus 2 includes a tray that accommodates the sheet P, a conveyor that conveys the sheet P supplied from the tray, and an image former that forms an image on the sheet P conveyed by the conveyor. The image former may be an inkjet image former that discharges ink onto the sheet P to form an image, or may be an electrophotographic image former that causes toner to adhere to the sheet P to form an image. Since the configuration of the image forming apparatus 2 is already known, detailed description thereof is omitted.

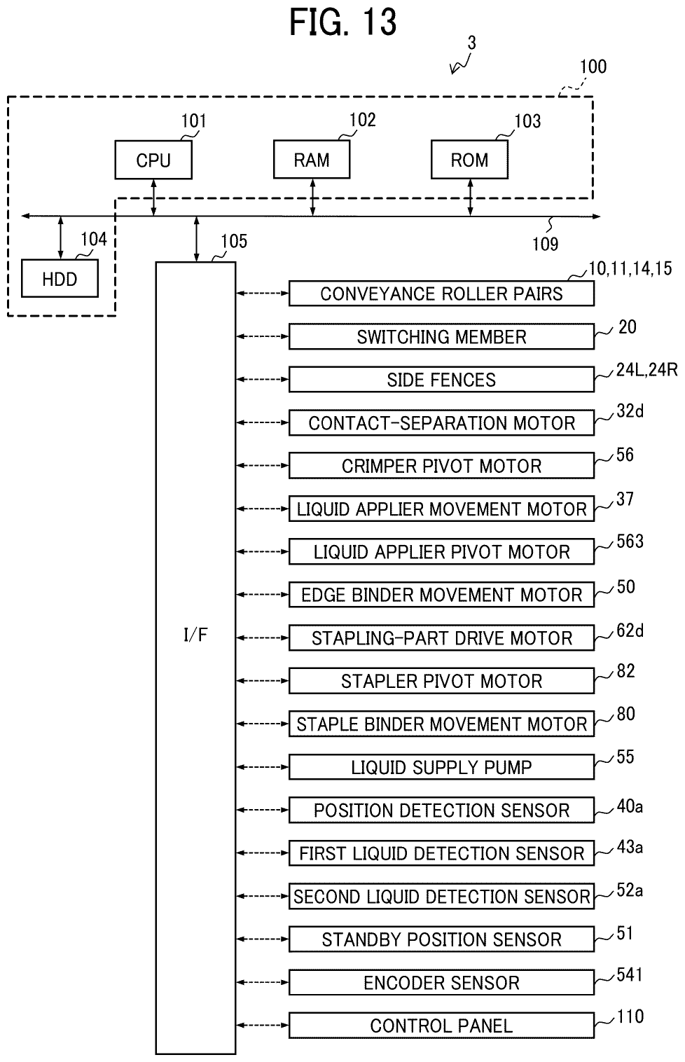

In FIG. 1, the post-processing apparatus 3 includes a controller 100 (control unit). Various types of processing executed in the post-processing apparatus 3 are implemented by control of the controller 100. Although the configuration of the controller 100 will be described later (see FIG. 13), the image forming apparatus 2 may have a similar configuration, and the controller 100 may control the operation of the post-processing apparatus 3.

### First Embodiment of Post-Processing Apparatus

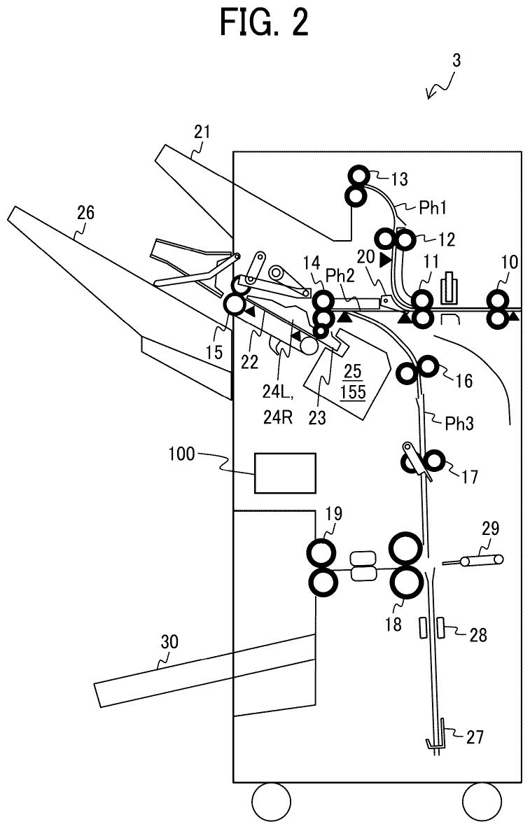

FIG. 2 is a view illustrating an internal configuration of the post-processing apparatus 3 serving as a medium processing apparatus according to a first embodiment of the present disclosure.

The post-processing apparatus 3 performs a given post-processing on the sheet P on which an image is formed by the image forming apparatus 2. An example of the post-processing according to the present embodiment is a binding process as a “crimp binding process” that binds, without a staple, a bundle (sheet bundle) of a plurality of sheets P. Another example of the post-processing according to the present embodiment is a binding process as a “staple binding process” that binds, with a staple, a bundle (sheet bundle) of a plurality of sheets P on which images have been formed. In the following description, a bundle (media bundle) of a plurality of sheets P is referred to as a “sheet bundle Pb”.

More particularly, the “crimp binding process” according to the present embodiment is a process called “crimp binding” that applies pressure to a binding position corresponding to a part of the sheet bundle Pb to deform (pressure-deform) the binding position and binds the sheet bundle Pb. The binding process that can be executed by the post-processing apparatus 3 includes edge binding and saddle binding. The edge binding is a process to bind an end of the sheet bundle Pb. The saddle binding is a process to bind a center portion of the sheet bundle Pb.

The post-processing apparatus 3 includes conveyance roller pairs 10 to 19 (conveyor) and a switching member 20. The conveyance roller pairs 10 to 19 convey, inside the post-processing apparatus 3, the sheet P supplied from the image forming apparatus 2. More specifically, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3.

The first conveyance passage Ph1 is a passage extending to a first output tray 21 from a supply port through which the sheet P is supplied from the image forming apparatus 2. The second conveyance passage Ph2 is a passage branching from the first conveyance passage Ph1 between the conveyance roller pairs 11 and 14 in a conveyance direction and extending to a second output tray 26 via an internal tray 22 serving as a receptacle. The third conveyance passage Ph3 is a passage branching from the first conveyance passage Ph1 between the conveyance roller pairs 11 and 14 in the conveyance direction and extending to a third output tray 30.

The switching member 20 is disposed at a branching position of the first conveyance passage Ph1 and the second conveyance passage Ph2. The switching member 20 can be switched between a first position and a second position. The switching member 20 in the first position guides the sheet P to be output to the first output tray 21 through the first conveyance passage Ph1. The switching member 20 in the second position guides the sheet P conveyed through the first conveyance passage Ph1 to the second conveyance passage Ph2. When a trailing end of the sheet P entering the second conveyance passage Ph2 passes through the conveyance roller pair 11, the conveyance roller pair 14 is rotated in reverse to guide the sheet P to the third conveyance passage Ph3. The post-processing apparatus 3 further includes a plurality of sensors that detects the positions of the sheet P in the first conveyance passage Ph1, the second conveyance passage Ph2, and the third conveyance passage Ph3. Each of the plurality of sensors is indicated by a black triangle mark in FIG. 2.

The post-processing apparatus 3 includes the first output tray 21. The sheet P output through the first conveyance passage Ph1 is placed on the first output tray 21. Among the sheets P supplied from the image forming apparatus 2, the sheets P on which the binding process is not performed are output to the first output tray 21.

The post-processing apparatus 3 further includes the internal tray 22 serving as a receptacle, an end fence 23, side fences 24L and 24R, an edge binder 25, a stapling unit 155, and the second output tray 26. The internal tray 22, the end fence 23, the side fences 24L and 24R, the edge binder 25, and the stapling unit 155 perform the edge binding on the sheet bundle Pb constructed of the plurality of sheets P conveyed through the second conveyance passage Ph2. Among the sheets P supplied from the image forming apparatus 2, the sheet bundle Pb subjected to the edge binding is output to the second output tray 26.

The “edge binding” includes “parallel binding”, “oblique binding”, and “vertical binding”. The “parallel binding” is a process to perform a binding process on the sheet bundle Pb along one side of the sheet bundle Pb parallel to a main scanning direction. The “oblique binding” is a process to perform a binding process on a corner of the sheet bundle Pb. The “vertical binding” is a process to perform binding on the sheet bundle Pb along one side of the sheet bundle Pb parallel to the conveyance direction.

In the following description, the direction in which the sheet P is conveyed from the conveyance roller pair 15 toward the end fence 23 is defined as a “conveyance direction” of the sheet P. In other words, the “conveyance direction” corresponds to a direction in which the sheet P that has been output from the image forming apparatus 2 is moved toward the end fence 23 by the conveyance roller pair 15 after being moved toward the second output tray 26 by, for example, the conveyance roller pair 10. The direction that is orthogonal to the conveyance direction and a thickness direction of the sheet P is defined as a “main scanning direction” or a “width direction of the sheet P.”

The plurality of sheets P that is sequentially conveyed through the second conveyance passage Ph2 is temporarily placed on the internal tray 22 serving as a receptacle. The end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the stapling unit 155 bind an end of the sheet bundle Pb aligned by the end fence 23 and the side fences 24L and 24R. Then, the conveyance roller pair 15 outputs the sheet bundle Pb subjected to the edge binding to the second output tray 26.

The post-processing apparatus 3 further includes an end fence 23, a saddle binder 28, a sheet folding blade 29, and the third output tray 30. The end fence 23, the saddle binder 28, and the sheet folding blade 29 perform the saddle binding on the sheet bundle Pb including the plurality of sheets P that is conveyed through the third conveyance passage Ph3. Among the sheets P supplied from the image forming apparatus 2, the sheet bundle Pb subjected to the saddle binding is output to the third output tray 30.

The end fence 23 aligns positions in the conveyance direction of the plurality of sheets P sequentially conveyed through the third conveyance passage Ph3. The end fence 23 is enabled to move between a binding position where the end fence 23 causes the center of the sheet bundle Pb to face the saddle binder 28 and a folding position where the end fence 23 causes the center of the sheet bundle Pb to face the sheet folding blade 29. The saddle binder 28 binds the center of the sheet bundle Pb aligned by the end fence 23 at the binding position. The sheet folding blade 29 folds, in half, the sheet bundle Pb placed on the end fence 23 at the folding position and causes the conveyance roller pair 18 to nip the sheet bundle Pb. The conveyance roller pairs 18 and 19 output the sheet bundle Pb subjected to the saddle binding to the third output tray 30.

The post-processing apparatus 3 includes, in the edge binder 25, a first liquid storage tank 43 serving as a first liquid storage and a first liquid supplier 45 as a part of a liquid applier. The first liquid storage tank 43 and the first liquid supplier 45 are omitted in FIG. 2. The post-processing apparatus 3 further includes a second liquid supplier 54 as a part of a liquid supplier, a liquid supply pump 55 as a part of the liquid supplier, a second liquid storage tank 53 as a part of a second liquid storage, and a second liquid storage tank fixer 52 as a part of the second liquid storage, to replenish the first liquid storage tank 43 with liquid. The liquid that is stored in the second liquid storage tank 53 is supplied to the first liquid storage tank 43 via the second liquid storage tank fixer 52, the liquid supply pump 55, and the second liquid supplier 54.

### Configuration of Edge Binder

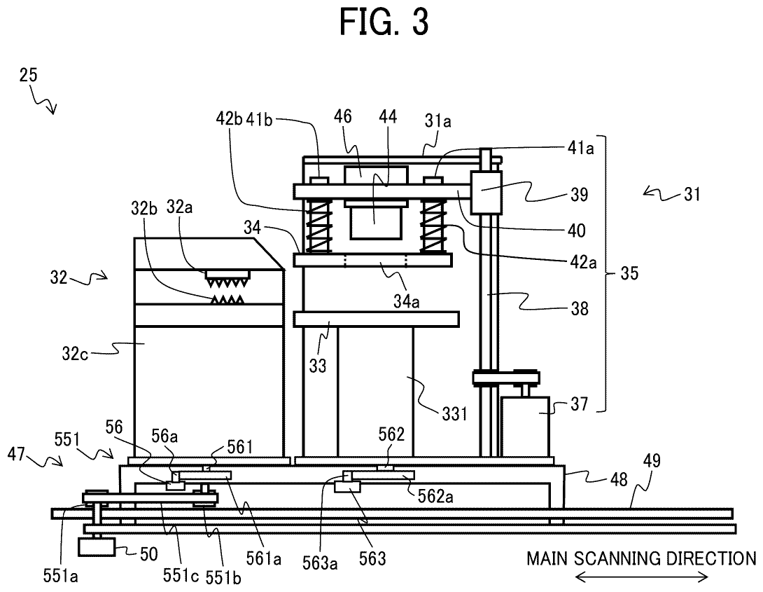

FIG. 3 is a schematic view of an upstream side of the edge binder 25 in the conveyance direction.

The edge binder 25 performs liquid application and crimp binding.

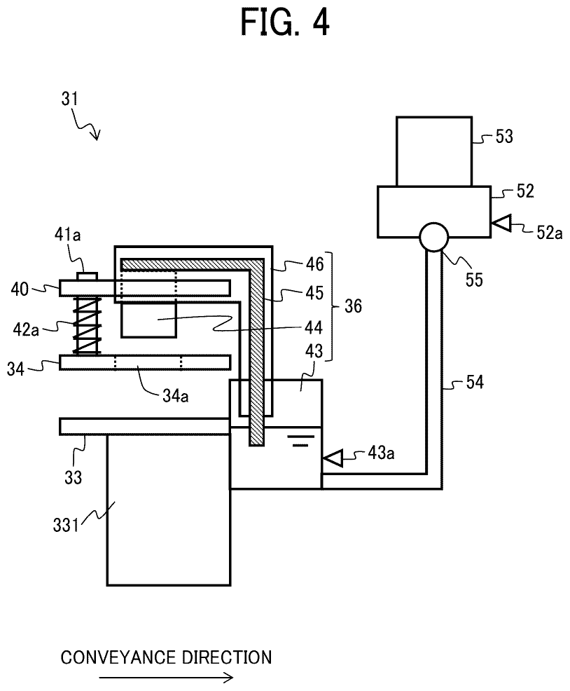

FIG. 4 is a schematic diagram illustrating a liquid applier 31 of the edge binder 25 when viewed from the main scanning direction.

As illustrated in FIG. 3, the edge binder 25 includes the liquid applier 31 and a crimper 32. The liquid applier 31 executes a processing operation related to the liquid application. The crimper 32 serves as a post-processing device and executes the crimp binding. The liquid applier 31 and the crimper 32 are disposed downstream from the internal tray 22 in the conveyance direction and adjacent to each other in the main scanning direction.

The liquid applier 31 applies the liquid that is stored in the first liquid storage tank 43 to the sheet P or the sheet bundle Pb placed on the internal tray 22. In the following description, the application of liquid to the sheet P or the sheet bundle Pb may be referred to as “liquid application” whereas a process to apply liquid may be referred to as “liquid application process”.

More specifically, the liquid that is stored in the first liquid storage tank 43 for the “liquid application” includes, as a main component, the liquid state of a compound of hydrogen and oxygen compound represented by the chemical formula H₂O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid may include an additive in addition to the main component. The liquid may include residual chlorine used as tap water. Preferably, for example, the liquid may include, as an additive, a colorant, a penetrant, a pH adjuster, a preservative such as phenoxyethanol, a drying inhibitor such as glycerin, or the like. Since water is used as a component of ink used for inkjet printers or ink used for water-based pens, such water or ink may be used for the “liquid application.”

The liquid is not limited to the specific examples described above. The liquid may be “water” in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above can enhance the binding strength of the sheet bundle Pb, as compared with a liquid of which the main component is not water.

The liquid applier 31 and the crimper 32 can be moved together in the main scanning direction by a driving force transmitted from the edge binder movement motor 50. A liquid application position or a liquid application region to which the liquid is applied on the sheet P or the sheet bundle Pb by the liquid applier 31 corresponds to a binding position or a binding region on the sheet bundle Pb to be crimped and bound by the crimper 32. For this reason, in the following description, the liquid application position (or the liquid application region) and the binding position (or the binding region) are denoted by the same reference numeral.

### Configuration of Liquid Applier

As illustrated in FIGS. 3 and 4, the liquid applier 31 can be moved in the main scanning direction together with the crimper 32 by the driving force transmitted from the edge binder movement motor 50.

The liquid applier 31 includes a lower pressure plate 33 serving as a receptacle for the sheet P or the sheet bundle Pb, an upper pressure plate 34, a liquid applier movement assembly 35, and a liquid application assembly 36. The components of the liquid applier 31 such as the lower pressure plate 33, the upper pressure plate 34, the liquid applier movement assembly 35, and the liquid application assembly 36 are held by a liquid application frame 31a and a base 48.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower-pressure-plate holder 331. The upper pressure plate 34 is movable in the thickness direction of the sheet P or the sheet bundle Pb at a position where the upper pressure plate 34 faces the sheet P or the sheet bundle Pb placed on the internal tray 22. In other words, the lower pressure plate 33 and the upper pressure plate 34 are arranged to face each other in the thickness direction of the sheet P or the sheet bundle Pb with the sheet P or the sheet bundle Pb stacked on the internal tray 22 and interposed between the lower pressure plate 33 and the upper pressure plate 34. In the following description, the thickness direction of the sheet P or the sheet bundle Pb may be referred to simply as “thickness direction”. The upper pressure plate 34 has a through hole 34a penetrating in the thickness direction at a position where the through hole 34a faces an end of a liquid application member 44, which is a part of the liquid applier, held via a holder 46 attached to a base plate 40.

The liquid applier movement assembly 35 moves the upper pressure plate 34, the base plate 40, the holder 46, the liquid application member 44, the first liquid supplier 45, and the first liquid storage tank 43 in the thickness direction of the sheet P or the sheet bundle Pb. The liquid applier movement assembly 35 according to the present embodiment moves the upper pressure plate 34, the base plate 40, the first liquid storage tank 43, the liquid application member 44, the first liquid supplier 45, and the holder 46 in conjunction with each other (in a unified way) by a single liquid applier movement motor 37. The liquid applier movement assembly 35 includes, for example, the liquid applier movement motor 37, a trapezoidal screw 38, a nut 39, the base plate 40, columns 41a and 41b, and coil springs 42a and 42b.

The liquid applier movement motor 37 generates a driving force to move the upper pressure plate 34, the base plate 40, the holder 46, the liquid application member 44, the first liquid supplier 45, and the first liquid storage tank 43. The trapezoidal screw 38 extends in the thickness direction of the sheet P or the sheet bundle Pb and is supported by the liquid application frame 31a of the liquid applier 31 so as to be rotatable in the forward and reverse directions. The trapezoidal screw 38 is coupled to an output shaft of the liquid applier movement motor 37 via, for example, a pulley and a belt. The nut 39 is screwed to the trapezoidal screw 38. The trapezoidal screw 38 is rotated in the forward and reverse directions by the driving force transmitted from the liquid applier movement motor 37. The rotation of the trapezoidal screw 38 causes the nut 39 to reciprocate on the trapezoidal screw 38.

The base plate 40 is positioned apart from the upper pressure plate 34. The base plate 40 holds the liquid application member 44 with the end of the liquid application member 44 projecting from the base plate 40 toward the upper pressure plate 34. The base plate 40 is coupled to the trapezoidal screw 38 via the nut 39 so as to reciprocate along the trapezoidal screw 38 when the trapezoidal screw 38 rotates in the forward and reverse directions. The position of the base plate 40 in the thickness direction of the sheet P or the sheet bundle Pb is detected by a position detection sensor 40a illustrated in FIG. 13.

The columns 41a and 41b project from the base plate 40 toward the upper pressure plate 34 around the end of the liquid application member 44. The columns 41a and 41b are movable relative to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40. The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid application assembly 36 applies liquid to the sheet P or the sheet bundle Pb placed on the internal tray 22. More particularly, the liquid applier 31 brings the liquid application member 44 into contact with the sheet P or the sheet bundle Pb to apply the liquid to at least one of sheets P of the sheet bundle Pb.

The liquid application assembly 36 includes a first liquid detection sensor 43a serving as a first liquid detector, the first liquid storage tank 43, the liquid application member 44, the first liquid supplier 45, and the holder 46. The first liquid storage tank 43 stores the liquid to be applied to the sheet P or the sheet bundle Pb. The amount of liquid that is stored in the first liquid storage tank 43 is detected by the first liquid detection sensor 43a. The first liquid storage tank 43 is coupled to the base plate 40 via the holder 46.

The liquid application member 44 applies the liquid stored in the first liquid storage tank 43 to the sheet P or the sheet bundle Pb. The liquid application member 44 and the first liquid supplier 45 disposed in close contact with the liquid application member 44 are both held by the holder 46. The holder 46 is held by the base plate 40. The holder 46 is an elongated cylindrical body (for example, a tube) that is fitted around the first liquid supplier 45. Such a configuration prevents the liquid absorbed by the first liquid supplier 45 from leaking or evaporating.

The first liquid supplier 45 has a first end in close contact with the liquid application member 44 and a second end immersed in the liquid stored in the first liquid storage tank 43. In other words, the second end of the first liquid supplier 45 corresponds to an immersion portion that sucks up the liquid and supplies the liquid to the liquid application member 44. Each of the liquid application member 44 and the first liquid supplier 45 is made of a material having a relatively high liquid absorption such as an elastic resin formed of open cells. For example, the liquid application member 44 and the first liquid supplier 45 may be made of sponge or fiber. Accordingly, when the other second end of the first liquid supplier 45 is immersed in the stored liquid, the liquid is sucked up by capillary action. As a result, the first liquid supplier 45 and the liquid application member 44 are filled with the liquid.

The liquid application member 44 according to the present embodiment has a planar end face. The liquid application member 44 according to the present embodiment is supported by the base plate 40 such that the end face is parallel to the sheet P or the sheet bundle Pb placed on the internal tray 22.

A liquid applier shaft 562 provided with a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of a liquid applier pivot motor 563. The liquid applier 31 can be rotated in the forward and reverse directions about the liquid applier shaft 562 on the base 48 by a driving force transmitted from the liquid applier pivot motor 563 to the liquid applier shaft 562 via the output gear 563a and the drive transmission gear 562a.

### Configuration of Second Liquid Storage

As illustrated in FIG. 4, the post-processing apparatus 3 includes the second liquid storage tank fixer 52 as a part of the second liquid storage, the second liquid storage tank 53 as a part of the second liquid storage, the second liquid supplier 54, and the liquid supply pump 55, to supply liquid to the first liquid storage tank 43. Here, a specific method of supplying the liquid to the first liquid storage tank 43 is not limited to the following example, and the user may directly supply the liquid to the first liquid storage tank 43.

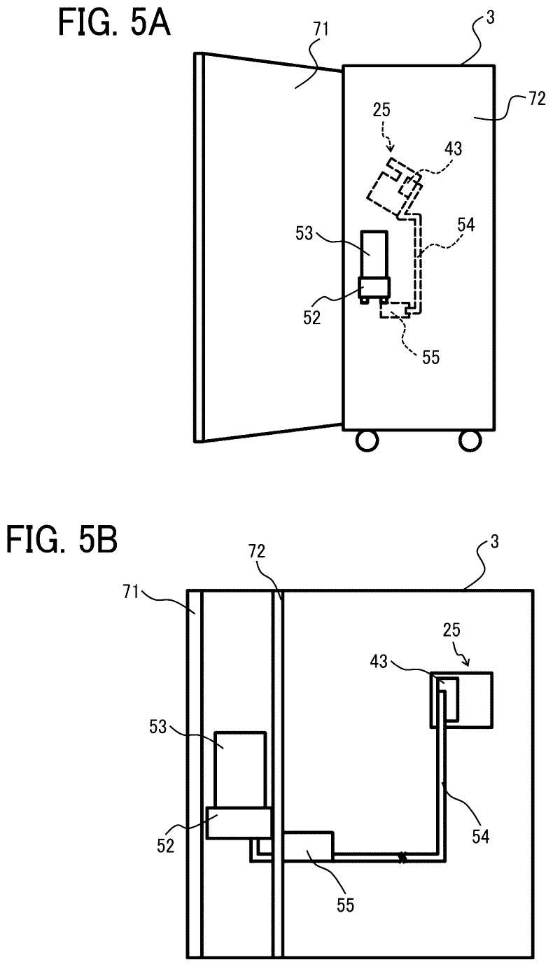

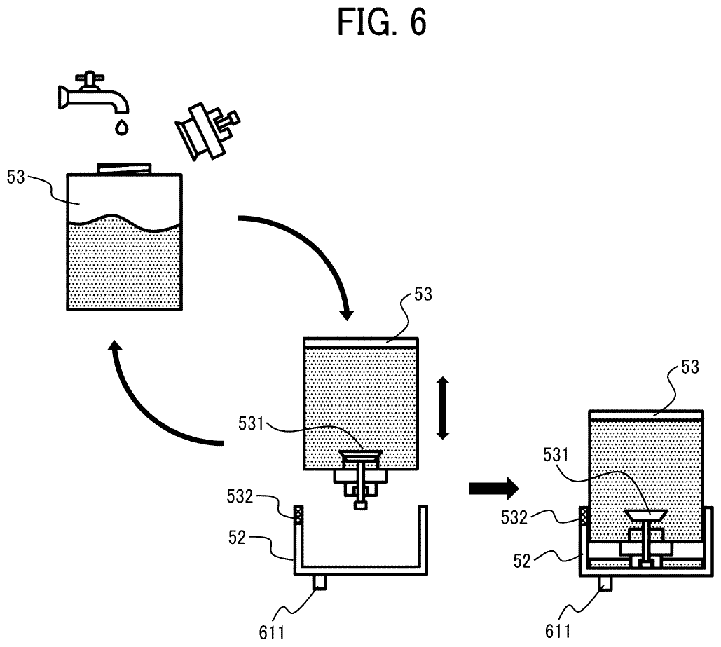

Referring now to FIGS. 5A to 6, a description is given of the location and configuration of the second liquid storage tank 53.

FIGS. 5A and 5B illustrate example location and configuration of the second liquid storage tank 53 as the main tank.

Specifically, FIG. 5A illustrates the post-processing apparatus 3 with a cover (i.e., a front door 71) opened.

FIG. 5B is a cross-sectional side view of the post-processing apparatus 3.

FIG. 5B illustrates the post-processing apparatus 3 with the cover (i.e., the front door 71) closed.

As illustrated in FIGS. 5A and 5B, the second liquid storage tank 53 is located so as to be accessible when the front door 71 of the post-processing apparatus 3 is opened.

A main-body side plate 72 of the post-processing apparatus 3 is disposed between where the second liquid storage tank 53 and the second liquid storage tank fixer 52 are disposed and where the first liquid storage tank 43 is disposed. The second liquid storage tank fixer 52 is provided with a liquid drain plug 611. After the liquid remaining in the first liquid storage tank 43 and the second liquid supplier 54 is reversely fed to the second liquid storage tank fixer 52, the liquid drain plug 611 is opened to discharge the liquid stored in the second liquid storage tank fixer 52 from the inside of the post-processing apparatus 3. Thus, the liquid is prevented from being frozen during maintenance of the post-processing apparatus 3.

FIG. 6 illustrates the second liquid storage tank 53 attachable to and detachable from the second liquid storage tank fixer 52 and replenished with liquid.

As illustrated in FIG. 6, the second liquid storage tank 53 is attachable to and detachable from the second liquid storage tank fixer 52 so as to be replenished with liquid. The second liquid storage tank fixer 52 is provided with a set sensor 532 that detects that the second liquid storage tank 53 is set in second liquid storage tank fixer 52. When the second liquid storage tank 53 is not set in the second liquid storage tank fixer 52, an outlet of the second liquid storage tank 53 is closed by a liquid supply valve 531 so that the liquid does not leak. When the second liquid storage tank 53 is set in the second liquid storage tank fixer 52, the liquid supply valve 531 is pushed up and the liquid stored in the second liquid storage tank 53 flows to the second liquid storage tank fixer 52, allowing the liquid to be stored in the second liquid storage tank fixer 52.

The second liquid storage tank fixer 52 stores the liquid to be supplied to the first liquid storage tank 43. The second liquid storage tank fixer 52 is attached to the main-body side plate 72 of the post-processing apparatus 3 outside the moving range, in the main scanning direction, of the edge binder 25 including the liquid applier 31. The amount of liquid that is stored in the second liquid storage tank fixer 52 is detected by a second liquid detection sensor 52a serving as a second liquid detector.

The second liquid storage tank 53, which is a liquid bottle, stores the liquid to be supplied to the second liquid storage tank fixer 52. The second liquid storage tank 53 is attachable to and detachable from the second liquid storage tank fixer 52. When the second liquid storage tank 53 is attached to the second liquid storage tank fixer 52, the liquid moves from the second liquid storage tank 53 to the second liquid storage tank fixer 52 until the amount of liquid in the second liquid storage tank fixer 52 reaches a second upper-limit value. When the amount of liquid in the second liquid storage tank fixer 52 reaches the second upper-limit value, the liquid stops moving from the second liquid storage tank 53 to the second liquid storage tank fixer 52.

The second liquid supplier 54 couples the second liquid storage tank fixer 52 and the first liquid storage tank 43 to each other. The second liquid supplier 54 supplies the liquid stored in the second liquid storage tank fixer 52 to the first liquid storage tank 43. The second liquid supplier 54 is, for example, a pipe, a hose, or a combination thereof. The diameter (inner diameter) of the second liquid supplier 54 is set to such a size that allows the speed (first supply speed) at which the liquid is supplied from the second liquid storage tank fixer 52 to the first liquid storage tank 43 through the second liquid supplier 54 to be higher than the speed (second supply speed) at which the liquid is supplied from the first liquid storage tank 43 to the liquid application member 44 through the first liquid supplier 45.

The liquid supply pump 55 is attached to the main-body side plate 72 of the post-processing apparatus 3 together with the second liquid storage tank fixer 52. The liquid supply pump 55 supplies (pumps) the liquid stored in the second liquid storage tank fixer 52 to the first liquid storage tank 43 through the second liquid supplier 54.

### Configuration of Crimper

As illustrated in FIG. 3, the crimper 32 serving as a crimping unit sandwiches, with serrate upper crimping teeth 32a and serrate lower crimping teeth 32b, at least a part (in other words, the liquid application position) of the sheet bundle Pb to which the liquid is applied by the liquid applier 31, to press and deform at least the part of the sheet bundle Pb. Thus, the crimper 32 binds the sheet bundle Pb. In the following description, such a binding way in which the upper crimping teeth 32a and the lower crimping teeth 32b sandwich and press the sheet bundle Pb to deform at least a part of the sheet bundle Pb may be referred to as “crimp binding”. In short, the crimper 32 binds the sheet bundle Pb without binding materials such as staples. The components of the crimper 32 such as the upper crimping teeth 32a and the lower crimping teeth 32b are disposed on a crimping frame 32c.

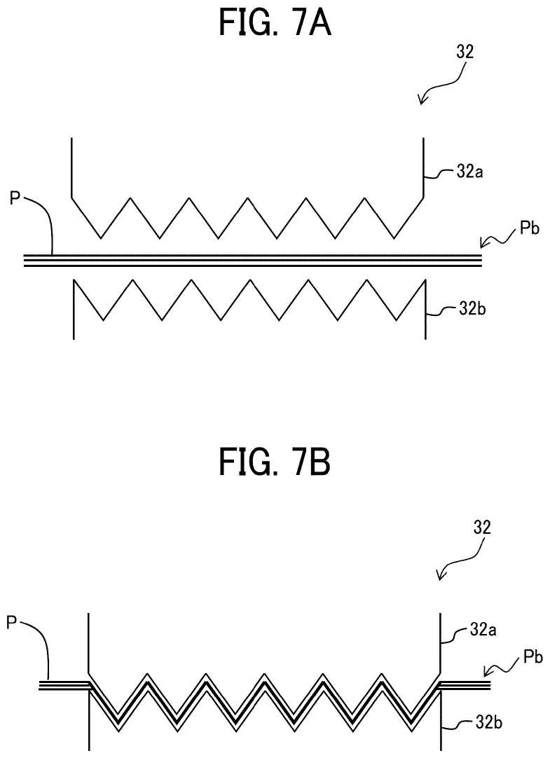

FIGS. 7A and 7B are schematic views illustrating the configuration of the crimper 32.

As illustrated in FIGS. 7A and 7B, the crimper 32 includes a pair of binding teeth (i.e., the upper crimping teeth 32a and the lower crimping teeth 32b). The upper crimping teeth 32a and the lower crimping teeth 32b are disposed to face each other in the thickness direction of the sheet bundle Pb to pinch the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by the driving force of a contact-separation motor 32d (see FIG. 13).

In the process of supplying the sheets P of the sheet bundle Pb to the internal tray 22, the upper crimping teeth 32a and the lower crimping teeth 32b are apart from each other as illustrated in FIG. 7A. When all the sheets P of the sheet bundle Pb are placed on the internal tray 22, the upper crimping teeth 32a and the lower crimping teeth 32b mesh with each other to press and deform the sheet bundle Pb in the thickness direction as illustrated in FIG. 7B. As a result, the sheet bundle Pb that has been placed on the internal tray 22 is crimped and bound. The sheet bundle Pb thus crimped and bound is output to the second output tray 26 by the conveyance roller pair 15.

The configuration of the crimper 32 as a crimping assembly is not limited to the configuration of a moving assembly exemplified in the present embodiment, provided that the upper crimping teeth 32a and the lower crimping teeth 32b of the crimping assembly mesh with each other. For example, a link assembly type crimping assembly (for example, disclosed in Japanese Patent No. 6057167) that performs crimping and separating operations of the upper crimping teeth 32a and the lower crimping teeth 32b using a link assembly and a drive source that perform only forward rotation or forward and reverse rotation may be used, or a linear motion type crimping assembly that linearly performs crimping and separating operations of the upper crimping teeth 32a and the lower crimping teeth 32b using a screw assembly that converts rotational motion of the drive source in the forward and reverse directions into linear reciprocating motion may be used.

A crimper shaft 561 provided with a drive transmission gear 561a is fixed to a bottom face of the crimping frame 32c that holds the components of the crimper 32. The crimper shaft 561 and the drive transmission gear 561a are held by the base 48 on which the crimping frame 32c is disposed, so as to be rotatable in the forward and reverse directions. The drive transmission gear 561a meshes with an output gear 56a of a crimper pivot motor 56. The crimper 32 can be rotated in the forward and reverse directions about the crimper shaft 561 on the base 48 by a driving force transmitted from the crimper pivot motor 56 to the crimper shaft 561 via the output gear 56a and the drive transmission gear 561a.

As illustrated in FIG. 3, the edge binder 25 includes an edge binder movement assembly 47. The edge binder movement assembly 47 moves the edge binder 25, specifically, the liquid applier 31 and the crimper 32, in the main scanning direction along a downstream end, in the conveyance direction, of the sheet P placed on the internal tray 22. The edge binder movement assembly 47 includes, for example, the base 48, a guide shaft 49, the edge binder movement motor 50, a driving force transmission assembly 551, and a standby position sensor 51 (see FIG. 13).

The liquid applier 31 and the crimper 32 are attached to the base 48 so as to be adjacent to each other in the main scanning direction. The guide shaft 49 extends in the main scanning direction at a position downstream from the internal tray 22 in the conveyance direction of the sheet P. The guide shaft 49 supports the base 48 such that the base 48 can move in the main scanning direction. The edge binder movement motor 50 generates a driving force to move the edge binder 25. The driving force transmission assembly 551 transmits the driving force of the edge binder movement motor 50 to the base 48 via pulleys 551a and 551b and a timing belt 551c.

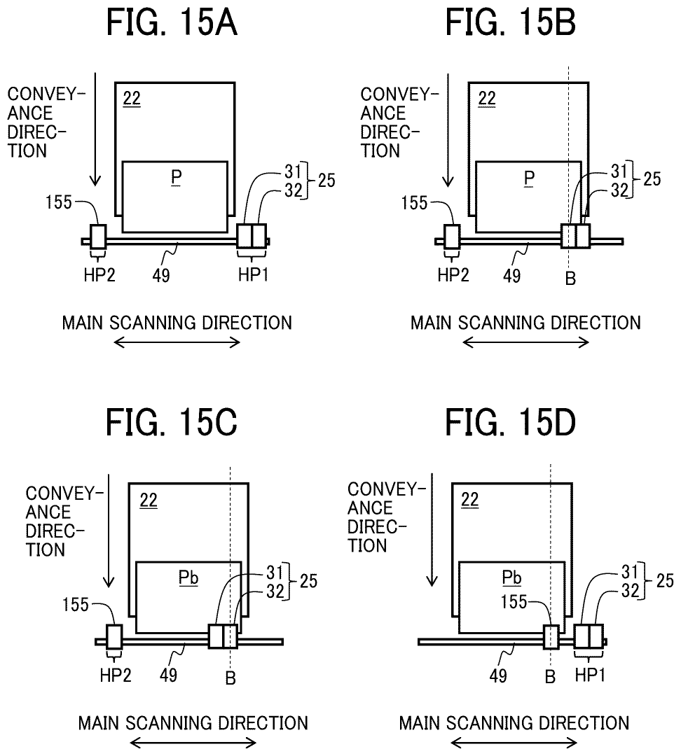

As a result, the liquid applier 31 and the crimper 32 integrated by the base 48 move in the main scanning direction along the guide shaft 49. The positions of the liquid applier 31 and the crimper 32 may be ascertained with, for example, an encoder sensor 541 (see FIG. 13). The encoder sensor 541 is attached to an output shaft of the edge binder movement motor 50. The standby position sensor 51 (see FIG. 13) detects the arrival of the edge binder 25 at a standby position HP1 illustrated in FIGS. 15A and 15D.

As illustrated in FIGS. 15A and 15D, the standby position HP1 is away in the width direction from the sheet P or the sheet bundle Pb placed on the internal tray 22. As illustrated in FIGS. 15B and 15C, the liquid applier 31 and the crimper 32 are movable along the guide shaft 49 to a position where the liquid applier 31 and the crimper 32 can face a binding position B (liquid application position B) on the sheet bundle Pb placed on the internal tray 22 in the main scanning direction.

### Configuration of Modification of Edge Binder

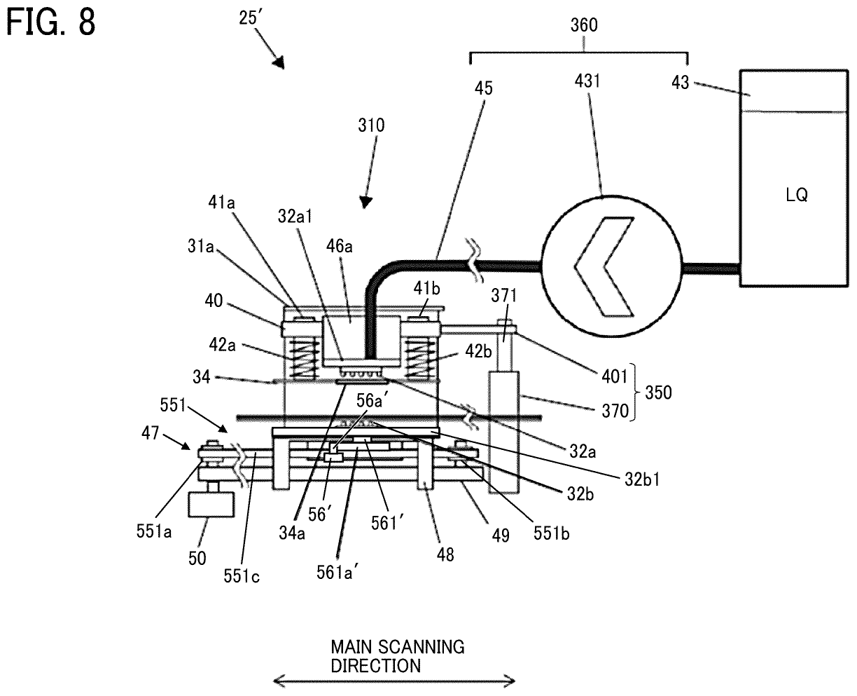

Specifically, referring now to FIGS. 8 to 10C, a description is given of an edge binder 25′ as a medium processing device and as a modification of the edge binder 25 included in the post-processing apparatus 3. The edge binder 25′ is different from the edge binder 25 described above in that the liquid applier 31 and the crimper 32 are integrated as a single unit. The components common to the components of the edge binder 25 described above are denoted by the same reference numerals, and a detailed description thereof may be omitted.

FIG. 8 is a schematic view of an upstream side of the edge binder 25′ in the conveyance direction.

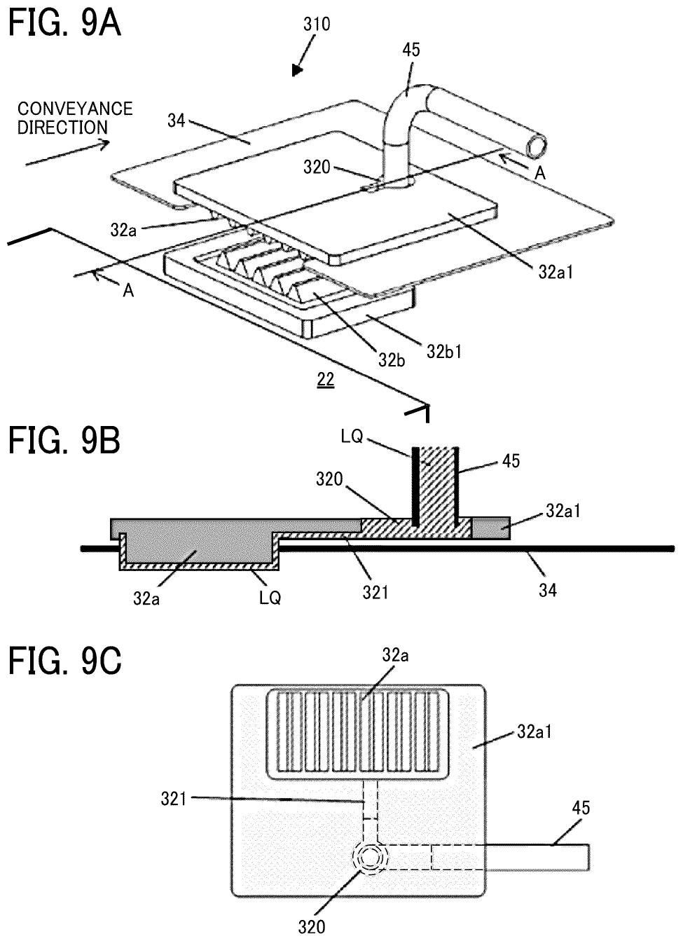

FIG. 9A is a perspective view of a liquid application crimper 310.

FIG. 9B is a cross-sectional view of the liquid application crimper 310 taken along line A-A in FIG. 9A.

FIG. 9C is a plan view of the upper crimping teeth 32a of FIG. 9A as viewed from where the lower crimping teeth 32b are disposed.

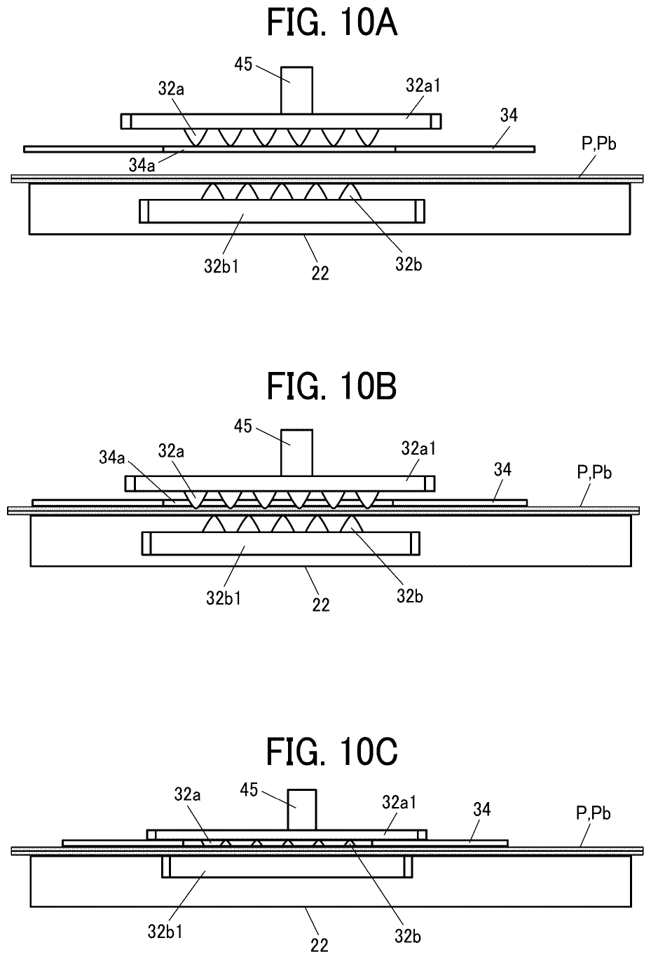

FIGS. 10A to 10C are diagrams illustrating a liquid application process and a crimp binding process performed by the liquid application crimper 310. In other words, FIGS. 10A to 10C are schematic views of a downstream side of the liquid application crimper 310 in the conveyance direction.

As illustrated in FIG. 8, the edge binder 25′ includes the liquid application crimper 310 in which the liquid applier 31 and the crimper 32 of the edge binder 25 according to the first embodiment are integrated as a single unit. The liquid application crimper 310 is disposed downstream from the internal tray 22 in the conveyance direction.

The liquid application crimper 310 applies liquid LQ stored in the first liquid storage tank 43 to the sheet P or the sheet bundle Pb placed on the internal tray 22. The liquid application crimper 310 can be moved in the main scanning direction by the driving force that is transmitted from the edge binder movement motor 50 to the base 48 by the driving force transmission assembly 551. The liquid application crimper 310 includes the upper pressure plate 34, the upper crimping teeth 32a, the lower crimping teeth 32b, a liquid application crimper movement assembly 350, and a liquid supply assembly 360. The components of the liquid application crimper 310 are held by the liquid application frame 31a and the base 48. A liquid application crimper shaft 561′ provided with a drive transmission gear 561a′ is fixed to a bottom face of the liquid application frame 31a. The liquid application crimper shaft 561′ and the drive transmission gear 561a′ are held by the base 48 on which the liquid application frame 31a is disposed, so as to be rotatable in the forward and reverse directions. The drive transmission gear 561a′ meshes with an output gear 56a′ of a liquid application crimper pivot motor 56′. The liquid application crimper 310 can be rotated in the forward and reverse directions about the liquid application crimper shaft 561′ on the base 48 by a driving force transmitted from the liquid application crimper pivot motor 56′ to the liquid application crimper shaft 561′ via the output gear 56a′ and the drive transmission gear 561a′.

The liquid application crimper movement assembly 350 moves the upper pressure plate 34, the base plate 40, and the upper crimping teeth 32a in cooperation with each other in the thickness direction of the sheet P or the sheet bundle Pb by an electric cylinder 370. The base plate 40 holds an upper-crimping-teeth holder 32a1 and the upper crimping teeth 32a via the holder 46. The base plate 40 movably holds the upper pressure plate 34 via the columns 41a and 41b. The base plate 40 is attached to an end of a rod 371 of the electric cylinder 370 via a connecter 401.

The columns 41a and 41b have respective lower ends holding the upper pressure plate 34. The coil springs 42a and 42b are fitted around the columns 41a and 41b, respectively, between the base plate 40 and the upper pressure plate 34. The coil springs 42a and 42b bias the upper pressure plate 34 and the columns 41a and 41b in a direction away from the base plate 40.

The liquid supply assembly 360 includes the first liquid storage tank 43, a liquid supply pump 431, and the first liquid supplier 45. The liquid supply pump 431 supplies the liquid LQ via the first liquid supplier 45 to a liquid reservoir 320 of the upper-crimping-teeth holder 32a1 as illustrated in FIG. 9A. The first liquid supplier 45 is an elastic elongated member having a base end (proximal end) coupled to the liquid supply pump 431 and a distal end coupled to the liquid reservoir 320.

As illustrated in FIG. 9B, the upper crimping teeth 32a are integrated with the upper-crimping-teeth holder 32a1. The upper-crimping-teeth holder 32a1 is provided with the liquid reservoir 320 and a liquid supply passage 321 for supplying the liquid LQ stored in the liquid reservoir 320 to the upper crimping teeth 32a. The surface of the upper crimping teeth 32a is subjected to a hydrophilic treatment so that the liquid LQ that is supplied through the liquid supply passage 321 uniformly spreads over the surface of the upper crimping teeth 32a. On the other hand, the portion of the upper-crimping-teeth holder 32a1 other than the upper crimping teeth 32a is subjected to a hydrophobic treatment so that the liquid LQ efficiently spreads over the surface of the upper crimping teeth 32a.

As illustrated in FIG. 8, the lower crimping teeth 32b are integrated with a lower-crimping-teeth holder 32b1, which is a part of the liquid application frame 31a. The lower crimping teeth 32b are attached to the base 48 via the lower-crimping-teeth holder 32b1.

Referring now to FIGS. 10A to 10C, a description is given of the liquid application process and the crimp binding process performed by the liquid application crimper 310.

In the process of supplying the sheet P to the internal tray 22, as illustrated in FIG. 10A, the upper crimping teeth 32a and the lower crimping teeth 32b are apart from each other. When the sheet P is placed on the internal tray 22, the electric cylinder 370 is contracted to move the upper crimping teeth 32a and the upper pressure plate 34 toward the sheet P. Then, as illustrated in FIG. 10B, the upper pressure plate 34 first contacts the sheet P, and then the upper crimping teeth 32a pass through the through hole 34a of the upper pressure plate 34 and contacts the sheet P. At this time, since the liquid LQ is spread over the surfaces of the upper crimping teeth 32a, bringing the upper crimping teeth 32a into contact with the sheet P allows the liquid to be applied to the liquid application position on the sheet P. When the liquid application to the liquid application position is completed, the electric cylinder 370 is extended to separate the upper crimping teeth 32a and the upper pressure plate 34 from the sheet P. The aforementioned contact and separation operation of the upper crimping teeth 32a and the upper pressure plate 34 with respect to the sheet P corresponds to the liquid application process, which is repeated on the sheets P of the sheet bundle Pb.

In response to reaching the number of the sheets P of the sheet bundle Pb placed on the internal tray 22 to a predetermined number, the electric cylinder 370 is further contracted to move the upper crimping teeth 32a toward the lower crimping teeth 32b. As illustrated in FIG. 10C, the upper crimping teeth 32a further moves toward the lower crimping teeth 32b with the sheet bundle Pb sandwiched between the upper crimping teeth 32a and the lower crimping teeth 32b. Thus, the upper crimping teeth 32a and the lower crimping teeth 32b press and deform the sheet bundle Pb to crimp and bind the sheet bundle Pb. In short, the crimp binding process is performed.

### Configuration of Stapling Unit

Specifically, a detailed description is now given of the stapling unit 155 having a function of executing a stapling process.

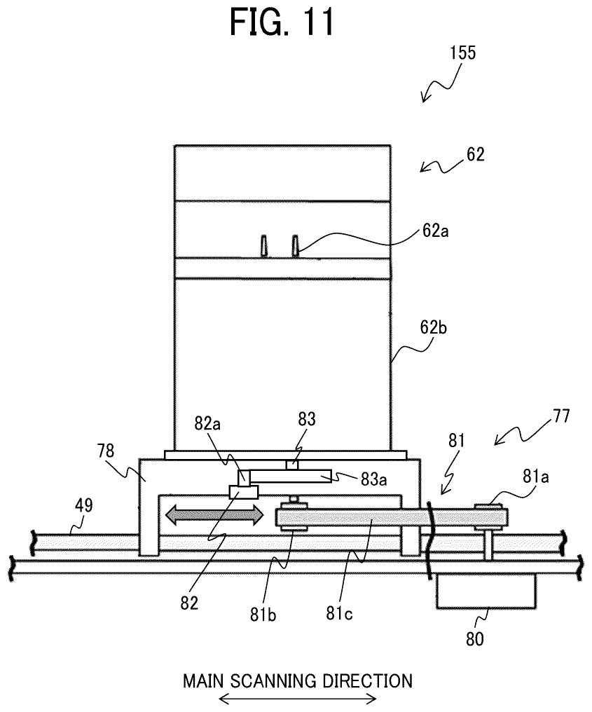

FIG. 11 is a view of an upstream side of the stapling unit 155 in the conveyance direction.

The stapling unit 155 includes a stapler 62 that binds the sheet bundle Pb with staples. The stapler 62 is disposed downstream from the internal tray 22 in the conveyance direction of the sheet P and spaced apart from the edge binder 25 in the main scanning direction.

The stapler 62 serving as a post-processing device has a configuration of performing so-called “stapling” (i.e., stapling process) to bind a sheet bundle Pb with a staple or staples. More particularly, the stapler 62 includes a stapling-part drive motor 62d (see FIG. 13) that drives the stapling part 62a. The driving force of the stapling-part drive motor 62d causes a staple loaded in the stapling part 62a to penetrate through a sheet bundle Pb, so that the stapling part 62a binds the sheet bundle Pb. Since the configuration of the stapler 62 is already known, detailed description thereof is omitted.

As illustrated in FIG. 11, the stapling unit 155 includes a stapling-unit movement assembly 77. The stapling-unit movement assembly 77 moves the stapling unit 155 in the main scanning direction along the downstream end, in the conveyance direction, of the sheet P or the sheet bundle Pb placed on the internal tray 22. In other words, the stapling unit 155 moves in the main scanning direction along the guide shaft 49 between a standby position HP2 as illustrated in FIGS. 15A to 15C and a position where the stapling unit 155 faces the binding position B as illustrated in FIG. 15D.

The stapling-unit movement assembly 77 includes, for example, a base 78, the guide shaft 49, a staple binder movement motor 80, and a driving force transmission assembly 81. The driving force transmission assembly 81 transmits a driving force of the staple binder movement motor 80 to the base 78 via pulleys 81a and 81b and a timing belt 81c. A stapler shaft 83 provided with a drive transmission gear 83a is fixed to a bottom face of a stapling frame 62b that holds the components of the stapler 62. The stapler shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 is rotatable in the forward and reverse directions about the stapler shaft 83 on the base 78 by a driving force transmitted from the stapler pivot motor 82 to the stapler shaft 83 via an output gear 82a and the drive transmission gear 83a.

The edge binder 25 and the stapling unit 155 are supported by the common guide shaft 49. The edge binder movement assembly 47 and the stapling-unit movement assembly 77 move the edge binder 25 and the stapling unit 155 in the main scanning direction along the common guide shaft 49. The edge binder movement assembly 47 and the stapling-unit movement assembly 77 can independently move the edge binder 25 and the stapling unit 155.

### Configuration of Modification of Stapling Unit

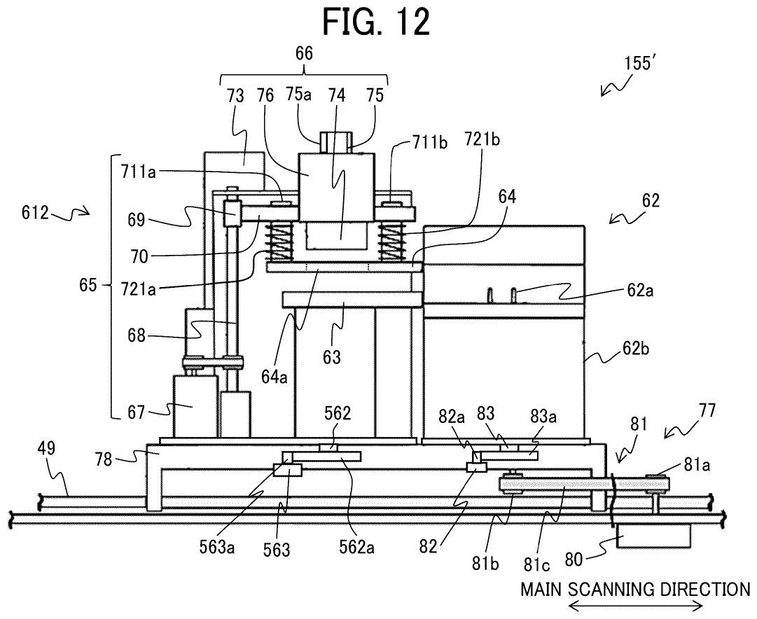

FIG. 12 illustrates a stapling unit 155′ as a modification of the stapling unit 155. Specifically, FIG. 12 is a view of an upstream side of the stapling unit 155′ in the conveyance direction.

The stapling unit 155′ is different from the stapling unit 155 in that the stapling unit 155′ includes a second liquid applier 612 in addition to the stapler 62.

As illustrated in FIG. 12, the stapling unit 155′ includes the second liquid applier 612 and the stapler 62. The second liquid applier 612 and the stapler 62 are disposed downstream from the internal tray 22 in the conveyance direction and adjacent to each other in the main scanning direction.

The second liquid applier 612 executes “liquid application” of applying liquid stored in a second liquid storage tank 73 to the sheet P or the sheet bundle Pb placed on the internal tray 22. A given region including a position to which the liquid is applied on the sheet P or the sheet bundle Pb by the second liquid applier 612 corresponds to a binding position to be stapled. As illustrated in FIG. 12, the second liquid applier 612 includes a second lower pressure plate 63, a second upper pressure plate 64 having a through hole 64a, a second liquid applier movement assembly 65, and a second liquid application assembly 66. The second liquid applier movement assembly 65 includes, for example, a second liquid applier movement motor 67, a second trapezoidal screw 68, a second nut 69, a second base plate 70, second columns 711 (711a and 711b), and second coil springs 721 (721a and 721b). The second liquid application assembly 66 includes the second liquid storage tank 73, a second liquid application member 74, a third liquid supplier 75 around which a protector 75a is fitted, and a second joint 76. Since the second liquid application assembly 66 and the liquid application assembly 36 have common configurations, redundant descriptions thereof is omitted. Since the configuration of the stapler 62 is like the configuration illustrated in FIG. 11, a detailed description thereof is omitted. Since the second liquid applier 612 and the liquid applier 31 illustrated in FIG. 3 have common pivot assemblies, redundant descriptions thereof is omitted.

In the binding process, the stapling unit 155′ that is illustrated in FIG. 12 performs the liquid application process on the sheet P to loosen and soften the binding position, allowing the staple to easily pass through the sheet bundle Pb. As a result, the number of sheets to be bound per sheet bundle Pb can be increased as compared with a case where the stapling process is performed without applying the liquid.

### Configuration of Control Block of Post-Processing Apparatus

FIG. 13 is a hardware configuration diagram of the post-processing apparatus 3.

As illustrated in FIG. 13, the post-processing apparatus 3 has a configuration in which a central processing unit (CPU) 101, a random access memory (RAM) 102, a read only memory (ROM) 103, a hard disk drive (HDD) 104, and an interface (I/F) 105 are coupled via a common bus 109.

The CPU 101 is an arithmetic unit and controls the operation of the overall operation of the post-processing apparatus 3.

The RAM 102 is a volatile storage medium that allows data to be read and written at high speed. The CPU 101 uses the RAM 102 as a working area for data processing.

The ROM 103 is a read-only non-volatile storage medium that stores programs such as firmware. The HDD 104 is a non-volatile storage medium that allows data to be read and written and has a relatively large storage capacity.

The HDD 104 stores, e.g., an operating system (OS), various control programs, and application programs.

The post-processing apparatus 3 processes, by an arithmetic function of the CPU 101, e.g., a control program stored in the ROM 103 and an information processing program (or application program) loaded into the RAM 102 from a storage medium such as the HDD 104. A software controller including various functional modules of the post-processing apparatus 3 executes such processing. The software controller thus configured cooperates with hardware resources of the post-processing apparatus 3 to construct functional blocks that implement functions of the post-processing apparatus 3. In other words, the CPU 101, the RAM 102, the ROM 103, and the HDD 104 construct a controller 100 as a control unit that controls the operation of the post-processing apparatus 3.

The I/F 105 is an interface that connects the conveyance roller pairs 10, 11, 14, and 15, the switching member 20, the side fences 24L and 24R, the contact-separation motor 32d, the crimper pivot motor 56, the liquid applier movement motor 37, the liquid applier pivot motor 563, the edge binder movement motor 50, the stapling-part drive motor 62d, the stapler pivot motor 82, the staple binder movement motor 80, the liquid supply pump 55, the position detection sensor 40a, the first liquid detection sensor 43a, the second liquid detection sensor 52a, the standby position sensor 51, the encoder sensor 541, and a control panel 110 to the common bus 109.

The controller 100 controls, via the I/F 105, the operations of the conveyance roller pairs 10, 11, 14, and 15, the switching member 20, the side fences 24L and 24R, the contact-separation motor 32d, the crimper pivot motor 56, the liquid applier movement motor 37, the liquid applier pivot motor 563, the edge binder movement motor 50, the stapling-part drive motor 62d, the stapler pivot motor 82, the staple binder movement motor 80, and the liquid supply pump 55. On the other hand, the controller 100 acquires detection results from the position detection sensor 40a, the first liquid detection sensor 43a, the second liquid detection sensor 52a, the standby position sensor 51, and the encoder sensor 541. Although FIG. 13 illustrates components related to the edge binder 25 that executes the edge binding and the stapling unit 155, components related to the saddle binder 28 that executes the saddle binding are similarly controlled by the controller 100.

As illustrated in FIG. 1, the image forming apparatus 2 includes the control panel 110. The control panel 110 includes an operation unit that receives instructions input by a user and a display serving as a notifier that notifies the user of information. That is, the control panel 110 corresponds to an operation selector. The control panel includes, for example, physical input buttons and a touch screen overlaid on a display. The control panel 110 acquires information from the user through the operation unit and provides the information to the user through the display. The specific example of the notifier is not limited to the display and may be, for example, a light emitting diode (LED) lamp or a speaker. The post-processing apparatus 3 may include a control panel 110 similar to the above-described control panel 110 of the image forming apparatus 2.

As described above, the post-processing apparatus 3 implements a function of performing operation control related to the liquid application by software (control programs) executed by the CPU 101 with hardware resources included in the controller 100.

### Description of Binding Process

A description is given below of a flow of the binding process executed by the edge binder 25 included in the post-processing apparatus 3.

The binding process described below is an example of a binding process involving liquid application. The controller 100 has a plurality of operation modes. For example, there are a “liquid application binding mode” for executing a binding process involving liquid application and a “rust adhesion prevention mode” to be described below.

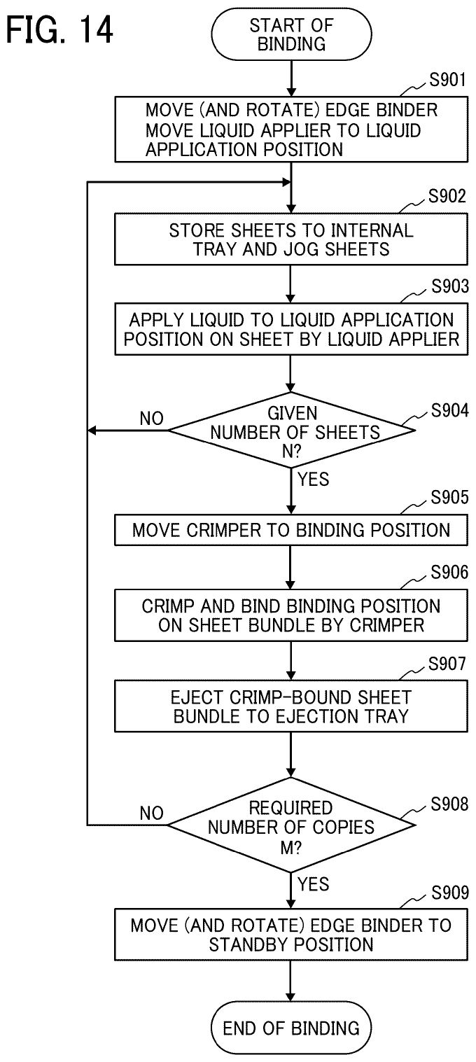

FIG. 14 is a flowchart of a binding process in the liquid application binding mode.

FIGS. 15A to 15D are diagrams illustrating the positions of the liquid applier 31 and the crimper 32 during the binding process.

Changes in the postures of the liquid applier 31 and the crimper 32 are omitted in FIGS. 15A to 15D. For example, the controller 100 starts the binding process illustrated in FIG. 14 when the controller 100 acquires an instruction to execute the binding process from the image forming apparatus 2. In the following description, the instruction to execute the binding process may be referred to as a “binding command.”

The binding command includes the condition for the crimp binding performed by the crimper 32, which may be referred to as “binding condition” in the following description. Examples of the binding condition include, but are not limited to, the type of the sheet P (i.e., information affecting the spread of liquid, such as material and thickness), the number of sheets P of the sheet bundle Pb, the number of sheet bundles Pb to be bound, the binding position B (liquid application position B) in the main scanning direction, the binding posture of the edge binder 25, and the operation mode selected through the control panel 110. In the following description, the number of sheets P of the sheet bundle Pb may be referred to as “given number N” whereas the number of sheet bundles Pb to be bound may be referred to as “requested number of copies M.” The liquid applier 31 and the crimper 32 are in the parallel binding posture and at the standby position HP1 (see FIG. 15A) at the start of the binding process. As illustrated in FIG. 15A, the standby position HP1 is away in the width direction from the sheet P placed on the internal tray 22.

First, as illustrated in FIG. 14, when the posture that is specified by the binding command is the “oblique binding posture,” in step S902, the controller 100 drives the crimper pivot motor 56 to rotate the liquid applier 31 and the crimper 32 of the edge binder 25 into the oblique binding posture. Alternatively, when the posture that is instructed by the binding command is the “oblique binding posture,” only the crimper 32 may be rotated to the oblique binding posture while the liquid applier 31 may not be rotated. In this case, the driving assembly may be simplified as compared with a case where both the liquid applier 31 and the crimper 32 are rotated, and thus effects of cost reduction, downsizing of the apparatus, and reduction of failure of the device are exhibited.

On the other hand, when the posture that is instructed by the binding command is the “parallel binding posture,” the controller 100 omits the aforementioned operation of rotating the liquid applier 31 and the crimper 32 of the edge binder 25 to the oblique binding posture. In step S901, the controller 100 also drives the edge binder movement motor 50 to move the edge binder 25 in the main scanning direction so that the liquid applier 31 faces a liquid application position B1 specified by the binding command. The controller 100 executes the processing of step S901 before the first sheet P is conveyed to the internal tray 22 by the conveyance roller pairs 10, 11, 14, and 15.

The controller 100 rotates the conveyance roller pairs 10, 11, 14, and 15 to store the sheet P on which the image is formed by the image forming apparatus 2 in the internal tray 22 (S902). Furthermore, the controller 100 aligns the positions of the ends in the main scanning direction of the sheet P stacked on the internal tray 22 by moving the side fences 24L and 24R to the opposing direction (so-called jogging process) (S902).

Subsequently, in step S902, the controller 100 causes the liquid applier 31 positioned at the liquid application position BI to execute the liquid application process on the sheet P, which has been placed on the internal tray 22 in the immediately preceding step S903. In other words, the controller 100 drives the liquid applier movement motor 37 to cause the liquid application member 44 to contact the liquid application position B on the sheet P placed on the internal tray 22 as illustrated in FIG. 15B.

More specifically, the controller 100 adjusts the time from when the liquid application member 44 comes into contact with the sheet P to when the liquid application member 44 starts to separate from the sheet P so as to be a contact time β set in the process for setting the contact time and the amount of movement. The controller 100 also adjusts the amount of movement of the liquid application member 44 toward the sheet P so as to be an amount of movement γ set in the process for setting the contact time and the amount of movement. As a result, the liquid is applied to the sheet P by a liquid application amount α set in the process for setting the amount of liquid to be applied.

A greater amount of liquid is applied from the liquid application member 44 to the sheet P as the contact time β increases. In addition, a greater amount of the liquid application member 44 is elastically deformed or crushed as the amount of movement γ increases. Thus, a greater amount of liquid is applied to the sheet P per unit time. In other words, the liquid application amount α increases as the contact time β increases. The liquid application amount α also increases as the amount of movement γ increases. The amount of movement γ indicates the area of contact between the liquid application member 44 and the sheet P or a pressure from the liquid application member 44 against the sheet P. The amount of movement γ may be controlled based on the amount of movement of the liquid application member 44 (in other words, the base plate 40) toward the sheet P. In other words, the amount of movement γ increases as the amount of movement of the liquid application member 44 toward the sheet P increases whereas the amount of movement γ decreases as the amount of movement of the liquid application member 44 toward the sheet P decreases.

Subsequently, in step S904, the controller 100 determines whether the number of sheets N accommodated in the internal tray 22 has reached the given number N instructed by the binding command. When the controller 100 determines that the number of sheets P accommodated in the internal tray 22 has not reached the given number N (NO in step S904), the controller 100 executes the operations of steps S902 and S903 again. In other words, the controller 100 executes the operations of steps S902 and S903 each time the sheet P is conveyed to the internal tray 22 by the conveyance roller pairs 10, 11, 14, and 15. The liquid applier 31 may execute the liquid application process on all or some of the plurality of sheets P of the sheet bundle Pb. For another example, the controller 100 may cause the liquid applier 31 to execute the liquid application process on the sheet P at intervals of one in every “n” sheets.

When the controller 100 determines that the number of sheets P accommodated in the internal tray 22 has reached the given number N (YES in step S904), in step S905, the controller 100 drives the edge binder movement motor 50 to move the edge binder 25 in the main scanning direction so that the crimper 32 faces the binding position B as illustrated in FIG. 15C.

Subsequently, in step S906, the controller 100 causes the crimper 32 to perform crimp binding on the sheet bundle Pb accommodated in the internal tray 22. In step S907, the controller 100 causes the conveyance roller pair 15 to output the sheet bundle Pb thus crimped and bound by the crimper 32 to the second output tray 26. Specifically, the controller 100 drives the contact-separation motor 32d to cause the upper crimping teeth 32a and the lower crimping teeth 32b to sandwich the binding position B on the sheet bundle Pb placed on the internal tray 22. The sheet bundle Pb is pressed and deformed between the upper crimping teeth 32a and the lower crimping teeth 32b. Thus, the crimper 32 crimps and binds the sheet bundle Pb. Thereafter, the controller 100 rotates the conveyance roller pair 15 to output the sheet bundle Pb thus crimped and bound to the second output tray 26.

On the sheet bundle Pb stacked on the internal tray 22, the binding region sandwiched by the upper crimping teeth 32a and the lower crimping teeth 32b in step S906 overlaps the liquid application region with which the leading end of the liquid application member 44 is in contact in step S903. In other words, the crimper 32 crimps and binds a region to which the liquid has been applied by the liquid applier 31 on the sheet bundle Pb placed on the internal tray 22. The binding region that is sandwiched by the upper crimping teeth 32a and the lower crimping teeth 32b may completely or partially overlap the liquid application region contacted by the end of the liquid application member 44, to obtain a sufficient binding strength.

Subsequently, in step S908, the controller 100 determines whether the number of sheet bundles Pb thus output has reached the requested number of copies M indicated by the binding command. When the controller 100 determines that the number of sheet bundles Pb thus output has not reached the requested number of copies M (NO in step $908), the controller 100 executes the operations of step S902 and the following steps again. In other words, when NO in step S908, the controller 100 repeats the operations of steps S902 to S907 until the number of sheet bundles Pb output to the second output tray 26 reaches the requested number of copies M.

When the controller 100 determines that the number of sheet bundles Pb output to the second output tray 26 has reached the requested number of copies M (YES in step S908), in step S909, the controller 100 drives the edge binder movement motor 50 to move the edge binder 25 to the standby position HP1 as illustrated in FIG. 15D. When the posture specified by the binding command is the “oblique binding posture”, the controller 100 drives the crimper pivot motor 56 to rotate the liquid applier 31 and the crimper 32 in such a way as to achieve the parallel binding posture in step S909. By contrast, when the posture that is instructed by the binding command is the “parallel binding posture,” the controller 100 omits the aforementioned operation of rotating the liquid applier 31 and the crimper 32 to the parallel binding posture. As a result, the liquid applier 31 and the crimper 32 return to the standby position HP1 position illustrated in FIG. 15D. In steps S901 and S909, the execution order of the movement in the main scanning direction and the rotation in the forward and reverse directions of the liquid applier 31 and the crimper 32 is not limited to the aforementioned order and may be reversed.

### Embodiment of Separation Assembly

A description is given below of a separation assembly included in the medium processing apparatus according to an embodiment of the present disclosure.

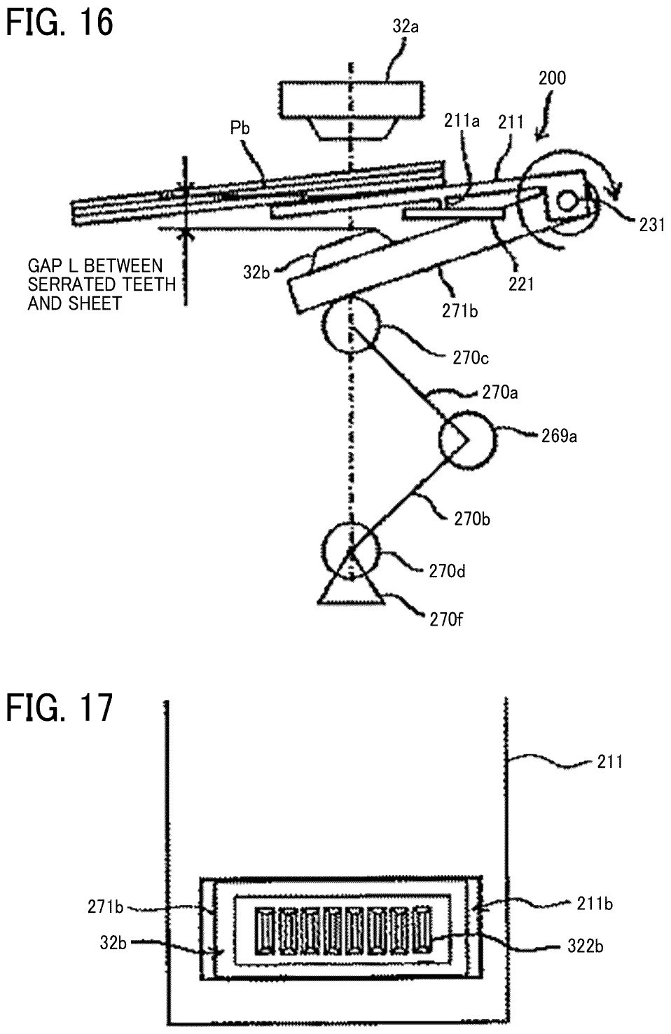

FIG. 16 is a diagram illustrating a separation assembly according to the present embodiment.

A separation assembly 200 according to the present embodiment has a function of separating the sheet bundle Pb bound by the binding unit from the binding unit or of separating at least one sheet P from the binding unit.

As illustrated in FIG. 16, the separation assembly 200 that comes into contact with the sheet bundle Pb and peels the sheet bundle Pb from the lower crimping teeth 32b when the lower crimping teeth 32b move from the binding position to a retraction position is provided within a movable range of the lower crimping teeth 32b. The separation assembly 200 includes a peeling member 211 which is a plate-like member that is in contact with a surface of the sheet bundle Pb on a side facing the lower crimping teeth 32b and is rotatable about the rotation shaft 231. The peeling member 211 is made of a material generally used for paper conveyance, such as a stainless steel plate, a plated steel plate, an ABS resin, or a polyacetal resin.

The separation assembly 200 includes a stopper 221 which is a rotation restricting member that restricts the rotational movement of the peeling member 211 by coming into contact with the protrusion 211a provided on the lower surface of the peeling member 211. When the protrusion 211a of the peeling member 211 and the stopper 221 come into contact with each other, the rotational movement of the peeling member 211 is restricted by the stopper 221 within a range smaller than the movable range of the lower crimping teeth 32b.

Further, the lower crimping teeth 32b are provided on a movable member 271b supported by the rotation shaft 231, the rotation center of the peeling member 211 is coaxial with the rotation shaft 231 of the movable member 271b, and the peeling member 211 is also rotatable in conjunction with the rotational movement of the lower crimping teeth 32b.

FIG. 17 is an enlarged view of the lower crimping teeth 32b.

As illustrated in FIG. 17, the peeling member 211 has an opening 211b through which serrate teeth 322b of the lower crimping teeth 32b can advance and retreat.

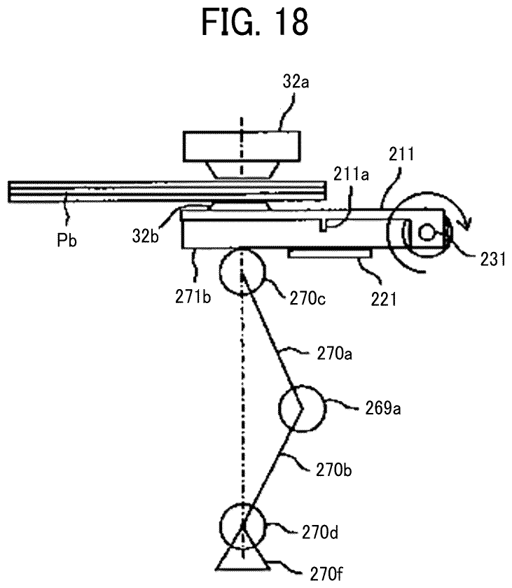

FIG. 18 is a view for describing a relationship with the peeling member 211 when the lower crimping teeth 32b are located at the binding position.

As illustrated in FIG. 18, when the lower crimping teeth 32b are located at the binding position, the lower surface of the peeling member 211 is in contact with the upper surface of the movable member 271b of the lower crimping teeth 32b. In this state, the teeth 322b of the lower crimping teeth 32b protrude from the opening 211b of the peeling member 211. As a result, the sheet bundle Pb can be bound by the pair of crimpers 32.

Liquid is applied to the sheet bundle Pb. Therefore, the liquid component (moisture) contained in the sheet bundle Pb adheres to the lower crimping teeth 32b, passes through the retractable opening 211b of the peeling member 211, and enters the gap between the lower crimping teeth 32b and the peeling member 211.

When moisture is left in the gap between the lower crimping teeth 32b and the peeling member 211, rust may occur in the lower crimping teeth 32b due to the trace amount of moisture. The rust reaches the teeth 322b and adheres to the sheet bundle Pb.

### Embodiments of the Present Disclosure

A description is given of a rust adhesion prevention mode in which rust can be prevented even if a liquid component (moisture) contained in the sheet bundle Pb adheres to the lower crimping teeth 32b when the post-processing apparatus 3 as an embodiment of the medium processing apparatus according to an embodiment of the present disclosure executes the crimp binding process involving liquid application.

The rust adhesion prevention mode is one of the operation modes of the post-processing apparatus 3. In the post-processing apparatus 3 in which the operation mode is set to the rust adhesion prevention mode, the crimp binding process is executed on the sheet P without applying liquid. By this crimp binding process, the liquid adhering to the lower crimping teeth 32b is adhered to the sheet P and removed. In addition, even in a case where the rust adhesion prevention mode is used, when the liquid adhering to the lower crimping teeth 32b cannot be completely removed and the rust is generated, similarly, the crimp binding process without liquid application is executed to cause the rust to adhere to and be removed with the sheet P. In this manner, by removing excessive moisture and rust from the lower crimping teeth 32b, it is possible to prevent rust from adhering to the sheet bundle Pb which is a printed matter desired by the user.

### Process Flow in Rust Adhesion Prevention Mode

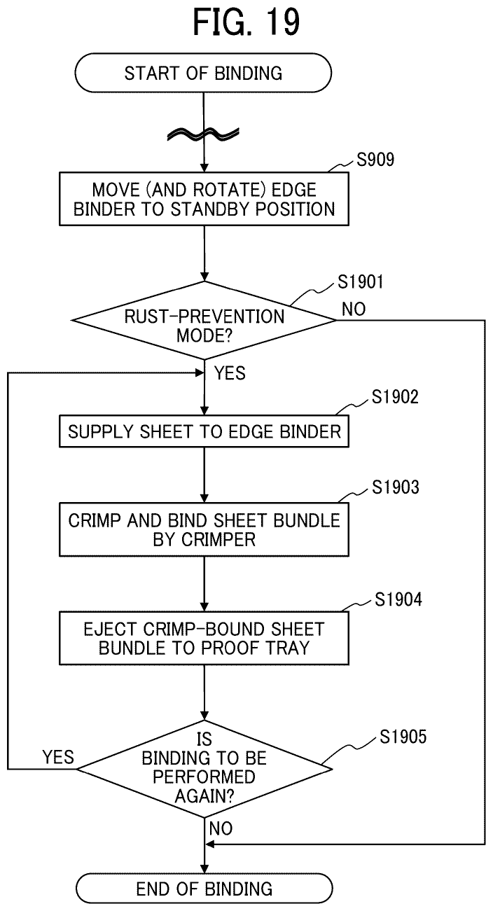

A description is given of the control process of the post-processing apparatus 3 in the rust adhesion prevention mode, with reference to a flowchart of FIG. 19.

FIG. 19 is a flowchart of a control process in a rust adhesion prevention mode.

The process related to the rust adhesion prevention mode is, for example, a process that can be executed after the binding process already described with reference to FIG. 14 is completed.

First, the controller 100 determines whether the set operation mode is the “rust adhesion prevention mode” (S1901). When the operation mode is not the rust adhesion prevention mode (S1901: NO), the rust adhesion prevention process ends, and the post-processing apparatus 3 waits for an instruction of the subsequent binding process.

When the operation mode is set to the rust adhesion prevention mode (S1901: YES), one sheet P is supplied from the sheet feeding tray of the image forming apparatus 2 to the edge binder 25 (S1902). Subsequently, the binding process is executed without applying the liquid in the crimp binding portion (S1903).

Subsequently, one sheet P subjected to the binding process in S1903 is ejected to the first output tray 21 (proof tray) in order to be distinguished from the other sheets P and the sheet bundle Pb (S1904).

Subsequently, when it is desired to confirm that the rust has not adhered to the sheet P, the rust adhesion prevention process is executed again according to an instruction of the user (S1905: YES). When the rust adhesion prevention process is not executed again (S1905: NO), the process ends.

### First Embodiment of Setting of Rust Prevention Mode

A description is given below of a first embodiment related to the setting operation of the rust adhesion prevention mode.

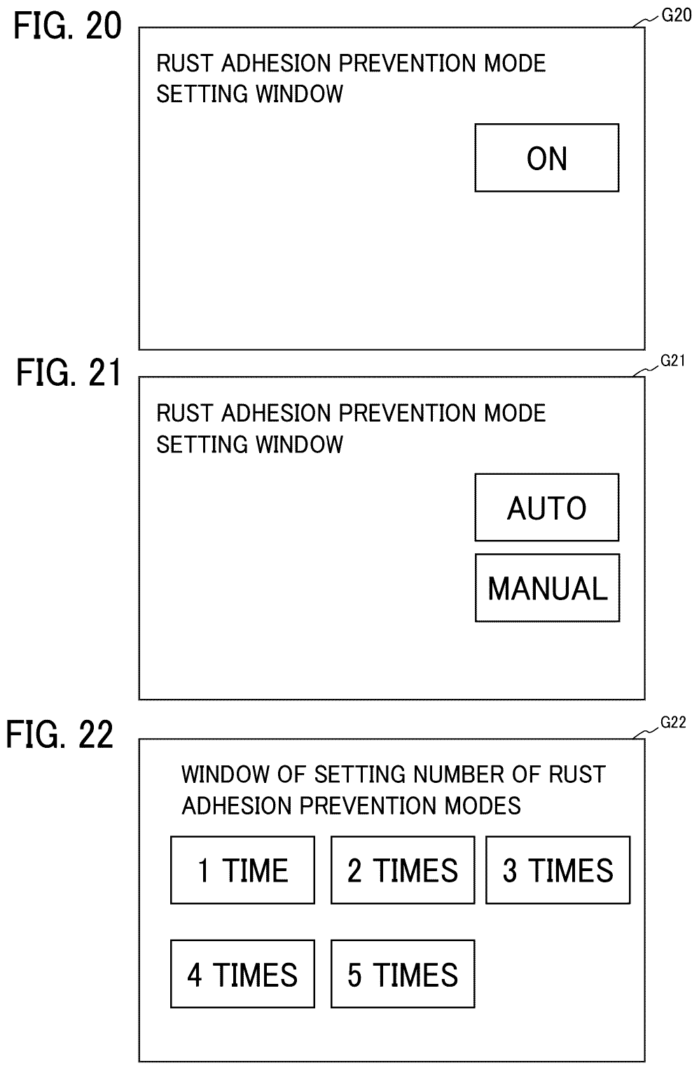

FIG. 20 is an example of a mode setting screen G20 that can be displayed on the control panel 110 as an operation selector.

The user can set a rust prevention mode at any timing through the mode setting screen G20. If the rust prevention mode is set to “ON” in advance on the mode setting screen G20, it is determined that the rust prevention mode is set in the above-described process S1901 (S1901: YES), and the process is performed.

### Second Embodiment of Setting of Rust Prevention Mode

A description is given below of a second embodiment related to the setting operation of the rust adhesion prevention mode.

FIG. 21 is an example of the mode automatic setting screen G21 that can be displayed on the control panel 110.

The mode automatic setting screen G21 is an example of an operation screen on which the user can arbitrarily select whether the rust adhesion prevention mode is automatically set or manually set in advance before the start of the job.

If “automatic” is selected before the start of the job, the process illustrated in FIG. 19 is automatically executed every time the job including the binding process involving liquid application ends.

If “manual” is selected before the start of the job, the process illustrated in FIG. 19 is not automatically executed each time the job including the binding process involving liquid application ends. In the case of “manual”, the user executes the process in a rust adhesion prevention mode at an arbitrary timing. For example, before the start of execution of the last job of the job executed in one day, the rust adhesion prevention process is executed after the end of the job by setting “manual” illustrated in FIG. 20.

### Third Embodiment of Setting of Rust Prevention Mode

A description is given below of a third embodiment related to the setting operation of the rust adhesion prevention mode.

FIG. 22 is an example of a mode setting count screen G22 that can be displayed on the control panel 110.

The mode setting count screen G22 is a screen for designating a condition under which the rust adhesion prevention mode is automatically set.

For example, when the number of executions of a job including the liquid application binding process reaches the selected condition number, the setting of the operation mode is changed to the rust adhesion prevention mode. For example, like the mode setting count screen G22, the user can arbitrarily set the number of repetitions of the binding process such as “1 time”, “2 times”, “3 times”, “4 times”, and “5 times”. As a result, regardless of the settings of “automatic” and “manual” as in the second embodiment, the operation in the rust adhesion prevention mode can be executed according to the set number of repetitions of the binding process.

### Second Embodiment of Post-Processing Apparatus

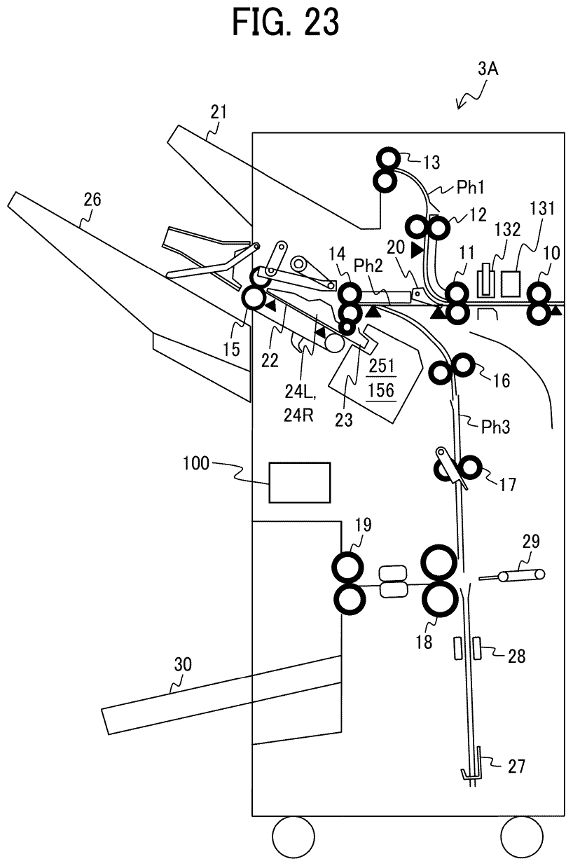

A description is given below of a post-processing apparatus 3A according to the second embodiment, with reference to FIGS. 23 to 31.

The components common to those of the post-processing apparatus 3 according to the first embodiment are denoted by the same reference numerals, and a detailed description thereof may be omitted.

An edge binder 251 of the post-processing apparatus 3A according to the second embodiment includes a crimper 32′, and a liquid applier 131 is provided on the upstream side of a conveyance passage. In this respect, the edge binder 251 is different from the edge binder 25 of the post-processing apparatus 3 according to the first embodiment in which the liquid applier 31 and the crimper 32 are provided together. Such a configuration allows a given number of sheets P to be pre-stacked after the liquid application process and conveyed to the crimper 32′ of the edge binder 251 provided on the downstream side. Accordingly, the productivity of the binding process performed by the crimper 32′ is enhanced.

Since a direction in which the conveyance roller pairs 10, 11, and 14 conveys the sheet P is opposite to the “conveyance direction” defined above, the direction is defined as a “reverse conveyance direction”. A direction that is orthogonal to both the opposite conveyance direction and the thickness direction of the sheet P is defined as the “main scanning direction” or the “width direction of the sheet P.” The liquid application position to which the liquid is applied on the sheet P or the sheet bundle Pb by the liquid applier 131 corresponds to the binding position on the sheet bundle Pb to be crimped and bound by the crimper 32′. For this reason, in the following description, the liquid application position and the binding position are denoted by the same reference sign.

FIG. 23 is a diagram illustrating an internal structure of the post-processing apparatus 3A according to the second embodiment of the present disclosure.

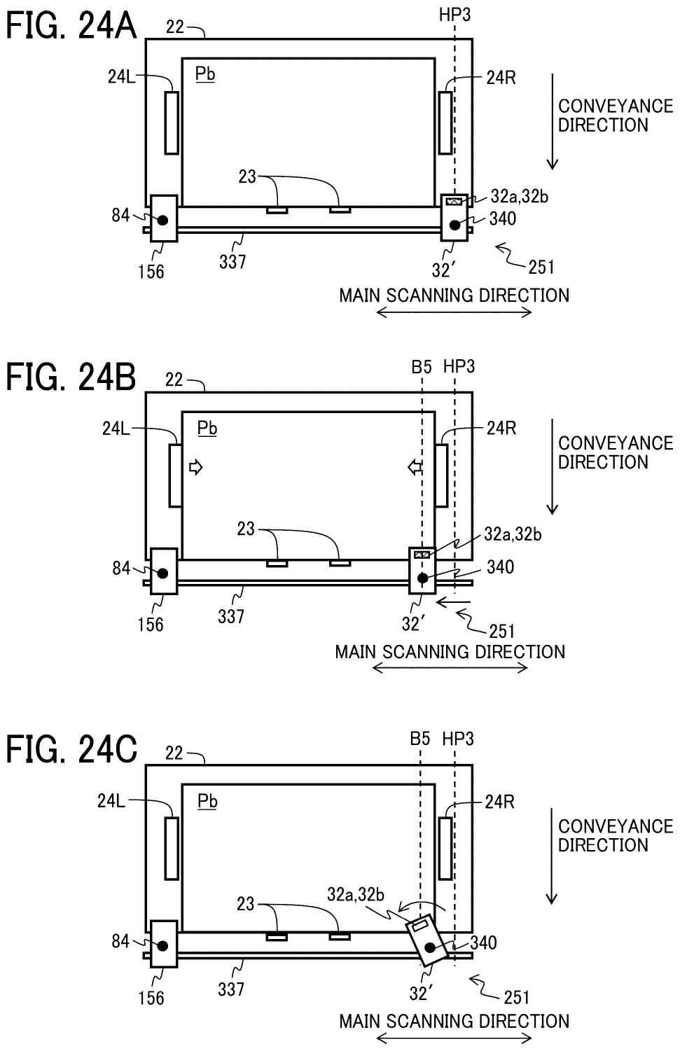

As illustrated in FIGS. 24A to 24C, the edge binder 251 includes the crimper 32′. As illustrated in FIG. 23, the crimper 32′ and a stapling unit 156 are disposed downstream from the internal tray 22 in the conveyance direction. In addition, the crimper 32′ and the stapling unit 156 are located to face the downstream end, in the conveyance direction, of the sheet bundle Pb placed on the internal tray 22 and is movable in the main scanning direction. Further, the crimper 32′ and the stapling unit 156 are respectively rotatable in the forward and reverse directions about a crimper shaft 340 and a stapler shaft 84 both extending in the thickness direction of the sheet bundle Pb placed on the internal tray 22. In other words, the crimper 32′ and the stapling unit 156 can bind the sheet bundle Pb placed on the internal tray 22 at a desired angle and at a desired position in the main scanning direction and perform, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb (hereinafter referred to as “crimp binding”). On the other hand, the stapling unit 156 passes the staple through a binding position on the sheet bundle Pb placed on the internal tray 22 to staple the sheet bundle Pb.

FIGS. 24A, 24B, and 24C are diagrams each illustrating the internal tray 22 of the post-processing apparatus as viewed from the thickness direction of the sheet bundle Pb.

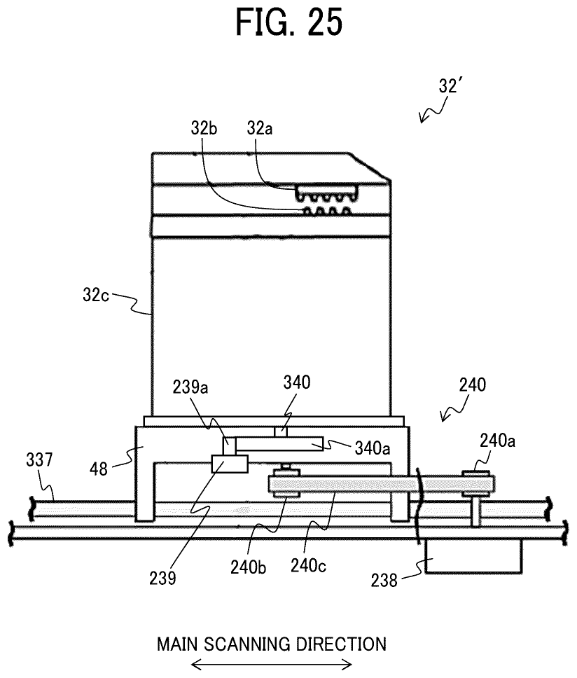

FIG. 25 is a schematic view of a downstream side of the crimper 32′ in the conveyance direction.

As illustrated in FIGS. 24A to 24C, the crimper 32′ and the stapling unit 156 are disposed downstream from the internal tray 22 in the conveyance direction. The crimper 32′ is movable in the main scanning direction along the surface of the sheet bundle Pb placed on the internal tray 22. The crimper 32′ is also rotatable in the forward and reverse directions about the crimper shaft 340 extending in the thickness direction of the sheet bundle Pb placed on the internal tray 22. Similarly, the stapling unit 156 is movable in the main scanning direction of the sheet bundle Pb and is rotatable in the forward and reverse directions about the stapler shaft 84 extending in the thickness direction of the sheet bundle Pb. Since the other configurations of the stapling unit 156 are like those of the stapling unit 155 (see FIG. 11) of the post-processing apparatus 3 according to the first embodiment, a detailed description thereof is omitted.

As illustrated in FIG. 25, the crimper 32′ includes a guide rail 337 extending in the main scanning direction at a position downstream from the internal tray 22 in the conveyance direction. The crimper 32′ is moved in the main scanning direction along the surface of the sheet bundle Pb placed on the internal tray 22 (in other words, along the guide rail 337) by a driving force that is transmitted from a crimper movement motor 238 by a drive transmission assembly 240 including pullies 240a and 240b and a timing belt 240c. The crimper shaft 340 provided with a drive transmission gear 340a is fixed to a bottom face of the crimping frame 32c that holds the components of the crimper 32′. The crimper shaft 340 and the drive transmission gear 340a are held by the base 48 on which the crimping frame 32c is disposed, so as to be rotatable in the forward and reverse directions. The drive transmission gear 340a meshes with an output gear 239a of a crimper pivot motor 239. The crimper 32′ is rotated in the forward and reverse directions on the base 48 about the crimper shaft 340 extending in the thickness direction of the sheet P placed on the internal tray 22, by a driving force transmitted from the crimper pivot motor 239 to the crimper shaft 340 via the output gear 239a and the drive transmission gear 340a. The guide rail 337, the crimper movement motor 238, the crimper pivot motor 239, the crimper shaft 340, and the drive transmission assembly 240 constitute at least part of a driving assembly of the crimper 32′ according to the present embodiment.

The crimper 32′ is movable between a standby position HP3 as illustrated in FIG. 24A and a position where the crimper 32′ faces a binding position B5 as illustrated in FIGS. 24B and 24C. The standby position HP3 is a position deviated to one side in the main scanning direction from the sheet bundle Pb stacked on the internal tray 22. The binding position B5 is a position on the sheet bundle Pb placed on the internal tray 22. However, the specific position of the binding position B5 is not limited to the position illustrated in FIGS. 24B and 24C. The binding position B5 may be one or more positions along the main scanning direction at the downstream end, in the conveyance direction, of the sheet P.

The posture of the crimper 32′ changes between the parallel binding posture illustrated in FIG. 24B and the oblique binding posture illustrated in FIG. 24C. In other words, the crimper 32′ is rotatable in the forward and reverse directions about the crimper shaft 340. The parallel binding posture is a posture of the crimper 32′ in which the length of the upper crimping teeth 32a and the lower crimping teeth 32b (in other words, a rectangular crimp binding trace) is along the main scanning direction. The oblique binding posture is a posture of the crimper 32′ in which the length of the upper crimping teeth 32a and the lower crimping teeth 32b (in other words, the rectangular crimp binding trace) is inclined with respect to the main scanning direction.

The rotational angle, which is an angle of the upper crimping teeth 32a and the lower crimping teeth 32b with respect to the main scanning direction, in the oblique binding posture is not limited to the angle illustrated in FIG. 24C. The rotational angle in the oblique binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132 serving as a processing device. The liquid applier 131 and the hole punch 132 are disposed upstream from the internal tray 22 in the opposite conveyance direction. In addition, the liquid applier 131 and the hole punch 132 are disposed at different positions in the opposite conveyance direction to simultaneously face one sheet P that is conveyed by the conveyance roller pairs 10 to 19. The liquid applier 131 and the hole punch 132 according to the present embodiment are disposed between the conveyance roller pairs 10 and 11. However, the arrangement of the liquid applier 131 and the hole punch 132 is not limited to the arrangement illustrated in FIG. 23. For example, in a case where an inserter 6 is disposed between the image forming apparatus 2 and the post-processing apparatus 3A as illustrated in FIG. 31, the liquid applier 131 may be disposed inside the inserter 6 located upstream from the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

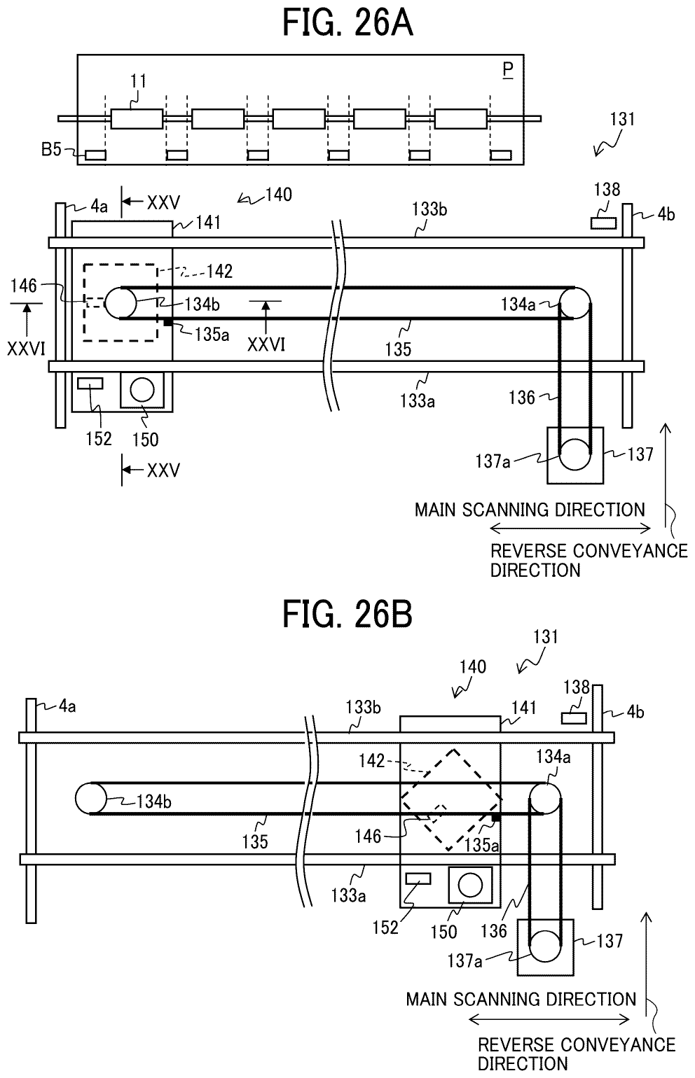

As illustrated in FIG. 26A, the conveyance roller pair 11 is located so as not to overlap, in the main scanning direction, the liquid application position B5 on the sheet P to which the liquid is applied by a liquid application head 146 of the liquid applier 131. This is to prevent the amount of liquid at the liquid application position B5 from decreasing due to the plurality of roller pairs contacting the liquid application position B5 when the conveyance roller pair 11 conveys the sheet P. As a result, when the sheet P reaches the crimper 32′ disposed downstream from the liquid applier 131 in the opposite conveyance direction, the amount of liquid at the liquid application position B5 is sufficient to maintain the binding strength. Accordingly, the binding strength of the sheet bundle Pb is prevented from decreasing due to a decrease in the amount of liquid at the liquid application position B5 (corresponding to the binding position B5) while the sheet P is conveyed.

In addition, the plurality of roller pairs of the conveyance roller pair 11 that is located so as not to overlap the liquid application position B5 on the sheet P in the main scanning direction prevents the conveying performance of the sheet P from being worse due to the adhesion of liquid to the plurality of roller pairs and further prevents a conveyance jam that may be caused by the worsened conveying performance of the sheet P.

Although only the conveyance roller pair 11 has been described above, it is preferred that the plurality of roller pairs of the conveyance roller pairs 14 to 15 is similarly arranged at positions not overlapping, in the main scanning direction, the liquid application position B5 of the sheet P.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processing device disposed near the liquid applier 131 is not limited to the hole punch 132. Alternatively, the processing device may be an inclination corrector that corrects an inclination or skew of the sheet P that is conveyed by the conveyance roller pairs 10 and 11.

FIGS. 26A and 26B are views of the liquid applier 131 in the thickness direction of the sheet P, according to the second embodiment of the present disclosure.

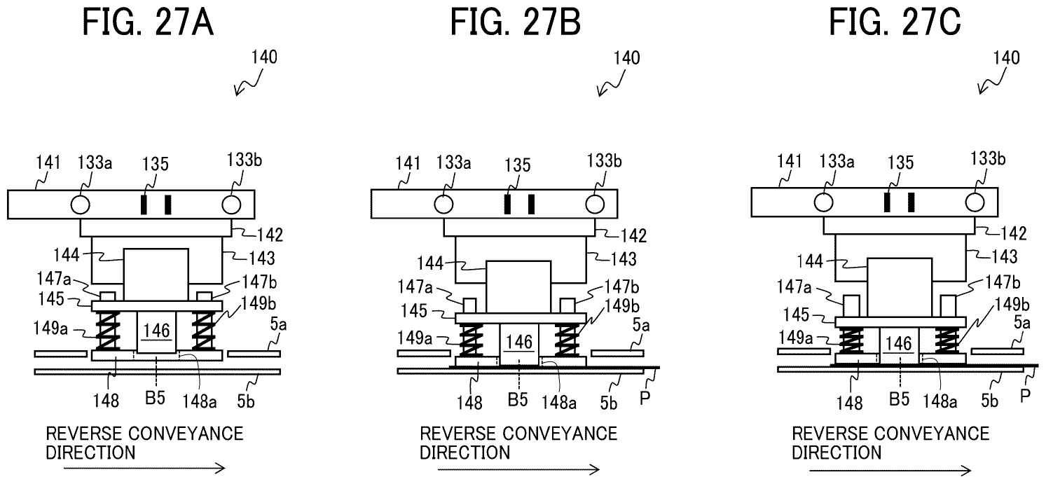

FIGS. 27A to 27C are cross-sectional views taken along XXV-XXV of FIG. 26A.

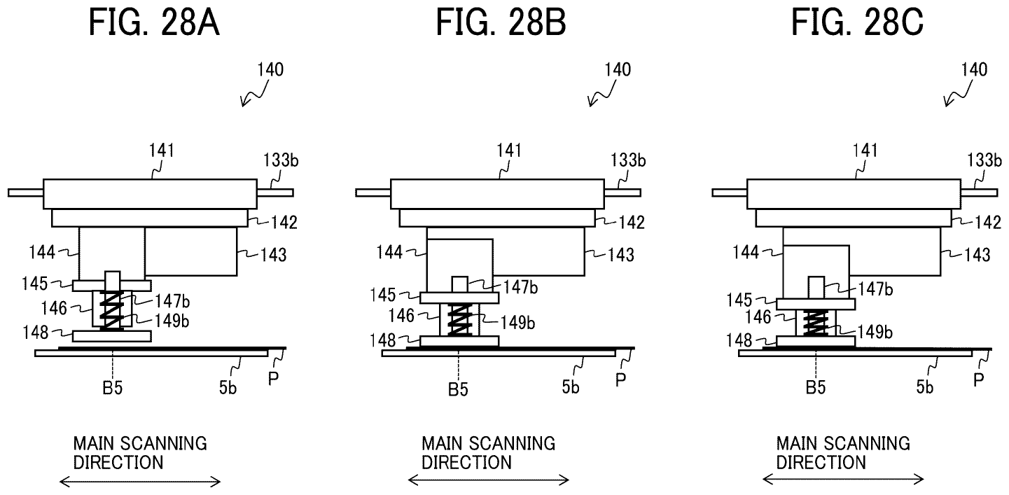

FIGS. 28A to 28C are cross-sectional views taken along XXVI-XXVI of FIG. 26A.

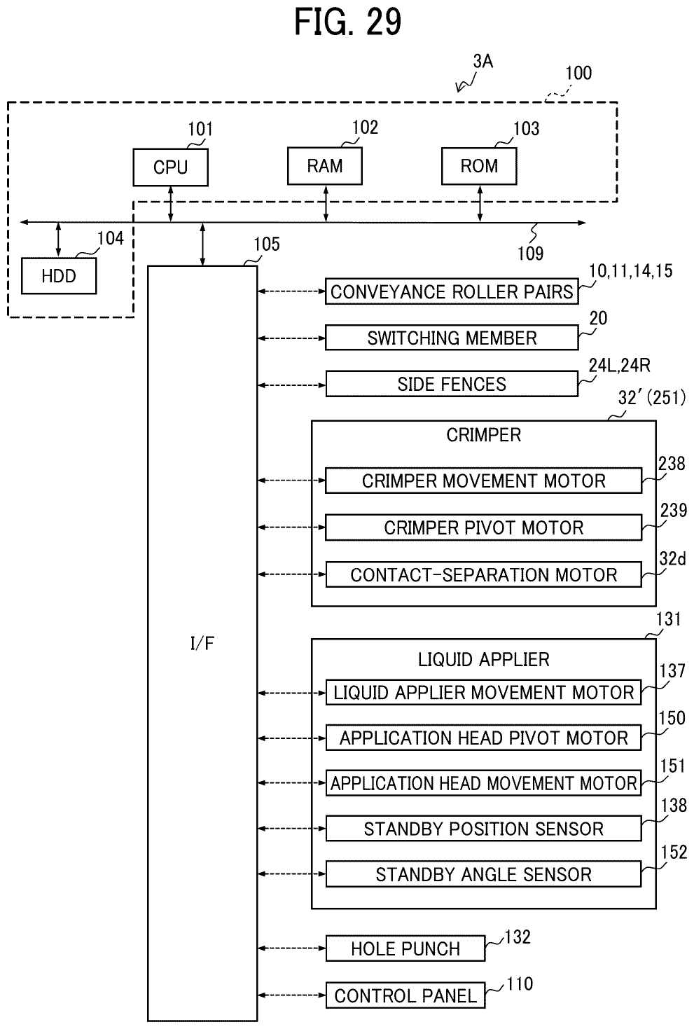

As illustrated in FIGS. 26A to 28C, the liquid applier 131 includes a pair of guide shafts 133a and 133b, a pair of pulleys 134a and 134b, endless annular belts 135 and 136, a liquid applier movement motor 137, a standby position sensor 138 (see FIG. 29), and the liquid application unit 140.

The pair of guide shafts 133a and 133b each extending in the main scanning direction are spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the pair of guide shafts 133a and 133b in the opposite conveyance direction. The pair of pulleys 134a and 134b are spaced apart from each other in the main scanning direction. The pair of pulleys 134a and 134b are supported by a frame of the post-processing apparatus 3A so as to be rotatable in the forward and reverse directions about the respective rotation shafts extending in the thickness direction of the sheet P.

The endless annular belt 135 is looped around the pair of pulleys 134a and 134b. The endless annular belt 135 is coupled to the liquid application unit 140 by a connection 135a. The endless annular belt 136 is entrained around the pulley 134a and a driving pulley 137a that is fixed to an output shaft of the liquid applier movement motor 137. The liquid applier movement motor 137 generates a driving force to move the liquid application unit 140 in the main scanning direction.

As the liquid applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to the rotation direction of the liquid applier movement motor 137 being switched.

The standby position sensor 138 detects the arrival of the liquid application unit 140 at a standby position in the main scanning direction. The standby position sensor 138 then outputs a standby position signal indicating the detection result to the controller 100 (see FIG. 29). The standby position sensor 138 is, for example, an optical sensor including a light emitter and a light receiver. The liquid application unit 140 at the standby position blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 27A to 27C, the conveyance passage inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 is disposed to face the conveyance passage (a position at which the liquid application unit 140 is to face the sheet P conveyed along the conveyance passage) through the opening of the upper guide plate 5a.

As illustrated in FIGS. 26A to 28C, the liquid application unit 140 includes a base 141, a rotary bracket 142, a liquid storage tank 143, a mover 144, a holder 145, the liquid application head 146, columns 147a and 147b, a pressure plate 148, coil springs 149a and 149b, an application head pivot motor 150, an application head movement motor 151 (see FIG. 29), and a standby angle sensor 152 (see FIG. 29).

The base 141 is supported by the pair of guide shafts 133a and 133b so as to be slidable in the main scanning direction. The base 141 is coupled to the endless annular belt 135 by the connection 135a. The base 141 supports the components of the liquid application unit 140, which are the rotary bracket 142, the liquid storage tank 143, the mover 144, the holder 145, the liquid application head 146, the columns 147a and 147b, the pressure plate 148, the coil springs 149a and 149b, the application head pivot motor 150, the application head movement motor 151, and the standby angle sensor 152.

The rotary bracket 142 is attached to the lower face of the base 141 so as to be rotatable in the forward and reverse directions about a rotation shaft extending in the thickness direction of the sheet P. The rotary bracket 142 is rotated in the forward and reverse directions with respect to the base 141 by a driving force transmitted from the application head pivot motor 150. On the other hand, the rotary bracket 142 holds the liquid storage tank 143, the mover 144, the holder 145, the liquid application head 146, the columns 147a and 147b, the pressure plate 148, and the coil springs 149a and 149b.

The standby angle sensor 152 (see FIG. 29) detects that the rotary bracket 142 has reached a standby angle. The standby angle sensor 152 then outputs a standby angle signal indicating the detection result to the controller 100. The standby angle is, for example, an angle for the parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 26A illustrates the rotary bracket 142 in a position for the parallel binding that is performed by the crimper 32′ disposed downstream from the liquid applier 131.

FIG. 26B illustrates the rotary bracket 142 in a position for the oblique binding (i.e., corner binding) that is performed by the crimper 32′ disposed downstream from the liquid applier 131.

The liquid storage tank 143 stores liquid to be applied to the sheet P. The mover 144 is attached to the liquid storage tank 143 so as to be movable (for example, up and down) in the thickness direction of the sheet P. The mover 144 is moved with respect to the liquid storage tank 143 by a driving force transmitted from the application head movement motor 151. The holder 145 is attached to a lower end of the mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a relatively high liquid absorption (e.g., sponge or fiber).

The columns 147a and 147b project downward from the holder 145 around the liquid application head 146. The columns 147a and 147b are movable relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 in a direction away from the holder 145.

As illustrated in FIGS. 27A and 28A, before the sheet P is conveyed to a position where the sheet P faces the opening of the upper guide plate 5a, the pressure plate 148 is positioned at or above the opening. Subsequently, when the sheet P that is conveyed by the conveyance roller pairs 10 and 11 stops at a position where the liquid application position B5 on the sheet P faces the opening, the application head movement motor 151 is rotated in a first direction. As a result, the mover 144, the holder 145, the liquid application head 146, the columns 147a and 147b, the pressure plate 148, and the coil springs 149a and 149b are moved down together to allow the pressure plate 148 to contact the sheet P. The liquid application position B5 is a position (that is, the binding position B5) scheduled to be crimped and bound by the edge binder 251 (that is, the crimper 32′).

As the application head movement motor 151 keeps rotating in the first direction after the pressure plate 148 contacts the sheet P, the coil springs 149a and 149b are compressed to further move down the mover 144, the holder 145, the liquid application head 146, and the columns 147a and 147b. As a result, as illustrated in FIGS. 27B and 28B, a lower face of the liquid application head 146 contacts the sheet P through the through hole 148a. As a result, the liquid contained in the liquid application head 146 is applied to the sheet P.

Further rotation of the application head movement motor 151 in the first direction further strongly presses the liquid application head 146 against the sheet P as illustrated in FIGS. 27C and 28C. Accordingly, the amount of liquid that is applied to the sheet P increases. In other words, the liquid applier 131 changes the pressing force of the liquid application head 146 against the sheet P to adjust the amount of liquid to be applied to the sheet P.

On the other hand, the rotation of the application head movement motor 151 in a second direction opposite to the first direction moves up the mover 144, the holder 145, the liquid application head 146, the columns 147a and 147b, the pressure plate 148, and the coil springs 149a and 149b together. As a result, as illustrated in FIGS. 27A and 28A, the liquid application head 146 and the pressure plate 148 are separated from the sheet P. In other words, the liquid applier 131 includes the liquid application head 146 that can be separated from the sheet P.

FIG. 29 is a hardware configuration diagram of a control block to control the operation of the post-processing apparatus 3A according to the second embodiment.

As illustrated in FIG. 29, the post-processing apparatus 3A has a configuration in which the CPU 101, the RAM 102, the ROM 103, the HDD 104, and the I/F 105 are coupled to each other via the common bus 109.

The CPU 101 is an arithmetic unit and controls the overall operation of the post-processing apparatus 3A.

The RAM 102 is a volatile storage medium that allows data to be read and written at high speed. The CPU 101 uses the RAM 102 as a working area for data processing.

The ROM 103 is a read-only non-volatile storage medium that stores programs such as firmware.

The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. A software controller including various functional modules of the post-processing apparatus 3A executes such processing. The software controller that is thus configured cooperates with hardware resources of the post-processing apparatus 3A to construct functional blocks that implement functions of the post-processing apparatus 3A. In other words, the CPU 101, the RAM 102, the ROM 103, and the HDD 104 construct the controller 100 that controls the operation of the post-processing apparatus 3A.

The I/F 105 is an interface that connects the conveyance roller pairs 10, 11, 14, and 15, the switching member 20, the side fences 24L and 24R, the crimper movement motor 238, the crimper pivot motor 239, the contact-separation motor 32d, the liquid applier movement motor 137, the application head pivot motor 150, the application head movement motor 151, the standby position sensor 138, the standby angle sensor 152, the hole punch 132, and the control panel 110 to the common bus 109. The controller 100 controls, via the I/F 105, the operations of the conveyance roller pairs 10, 11, 14, and 15, the switching member 20, the side fences 24L and 24R, the crimper movement motor 238, the crimper pivot motor 239, the contact-separation motor 32d, the liquid applier movement motor 137, the application head pivot motor 150, the application head movement motor 151, and the hole punch 132.

On the other hand, the controller 100 acquires, via the I/F 105, detection results from the standby position sensor 138 and the standby angle sensor 152. Although FIG. 29 mainly illustrates the components of the liquid applier 131 and the edge binder 251 (the crimper 32′) that executes the edge binding, the components of the saddle binder 28 that executes the saddle binding are controlled by the controller 100 as with the components of the liquid applier 131 and the edge binder 251 (the crimper 32′).

The control panel 110 includes an operation unit that receives instructions input by a user and a display serving as a notifier that notifies the user of information. The control panel includes, for example, physical input buttons and a touch screen overlaid on a display. The control panel 110 acquires information from the user through the operation unit and provides the information to the user through the display.

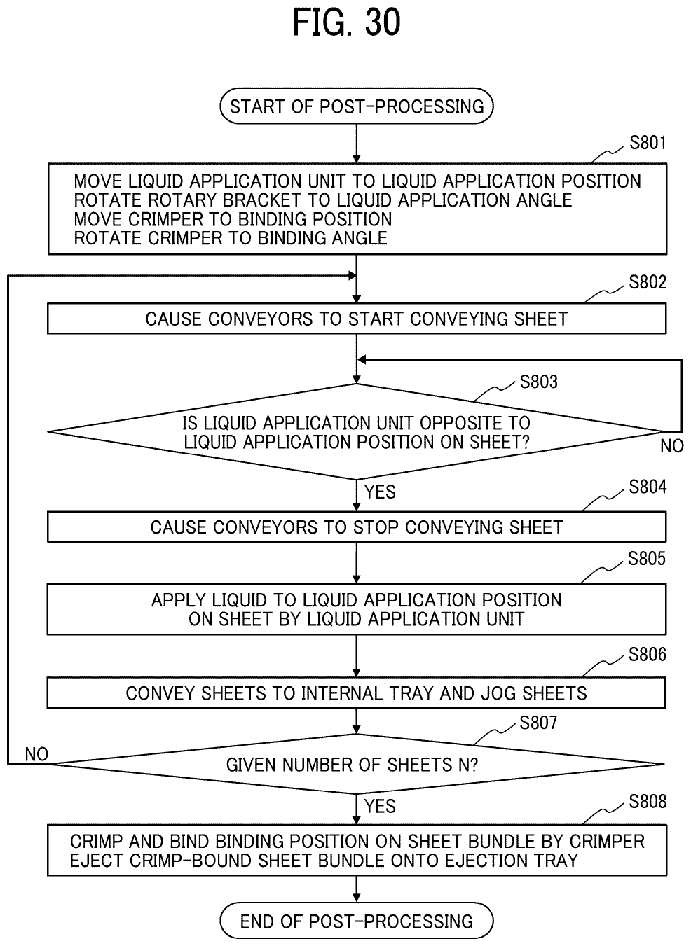

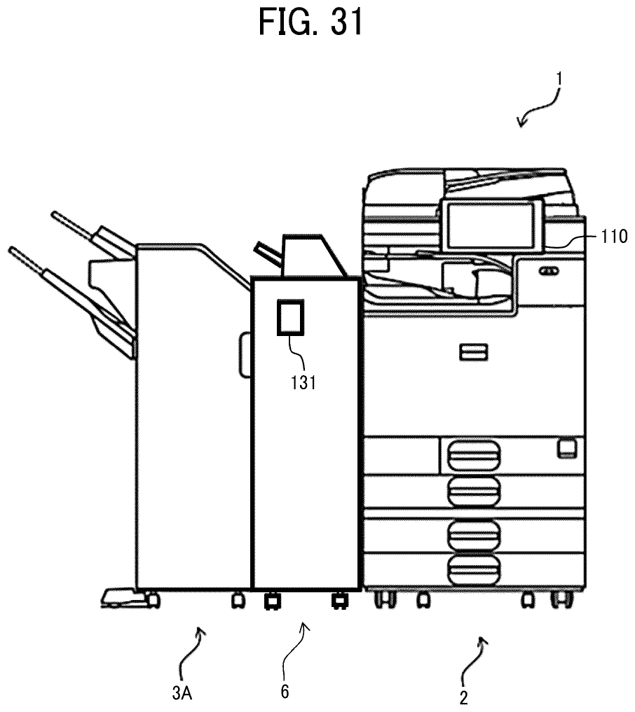

FIG. 30 is a flowchart of post-processing performed by the post-processing apparatus 3A according to the second embodiment.

Specifically, FIG. 30 is a flowchart of a process to execute the one-point binding illustrated in FIGS. 24A to 24C.

For example, the controller 100 executes the post-processing illustrated in FIG. 30 when the controller 100 acquires an instruction to execute the post-processing from the image forming apparatus 2. In the following description, the instruction to execute the post-processing may be referred to as a “post-processing command.” The post-processing command includes, for example, the number of sheets P of the sheet bundle Pb, the number of sheet bundles Pb to be bound, the binding position B5 (corresponding to the liquid application position B5), the angle at the binding position B5 (corresponding to an angle at the liquid application position B5), the type of binding (for example, the parallel binding or the oblique binding), and the process that is executed in parallel with the liquid application process (i.e., punching a hole in the present embodiment). In the following description, the number of sheets P of the sheet bundle Pb may be referred to as “given number N” whereas the number of sheet bundles Pb to be bound may be referred to as “requested number of copies M.” At the start of the post-processing, the liquid application unit 140 is at the standby position HP3 (corresponding to the standby position HP3 illustrated in FIGS. 24A to 24C) whereas the rotary bracket 142 is held at the standby angle (corresponding to the “parallel binding posture”).

First, the controller 100 drives the liquid applier movement motor 137 to move the liquid application unit 140 (corresponding to the liquid applier) in the main scanning direction such that liquid application head 146 moves from the standby position HP3 to a position where the liquid application head 146 can face the liquid application position B5 (corresponding to the binding position B5 illustrated in FIGS. 24B and 24C). When the type of binding that is instructed by the post-processing command is the “oblique binding,” in step S801, the controller 100 also drives the application head pivot motor 150 to rotate the rotary bracket 142 such that the liquid application head 146 rotates from the standby angle to a liquid application angle corresponding to the “oblique binding posture.” It is ascertained based on a pulse signal output from a rotary encoder of the liquid applier movement motor 137 that the liquid application head 146 has reached the position where the liquid application head 146 can face the liquid application position B5. Similarly, it is ascertained based on a pulse signal output from a rotary encoder of the application head pivot motor 150 that the liquid application head 146 has reached the liquid application angle. When the type of binding that is instructed by the post-processing command is the “parallel binding,” the controller 100 omits the aforementioned operation of rotating the rotary bracket 142. In other words, the liquid application unit 140 moves in the main scanning direction while holding the rotary bracket 142 at the standby angle.

In step S801, the controller 100 also drives the crimper movement motor 238 to move the crimper 32′ from the standby position HP3 to the position where the crimper 32′ can face the binding position B5 as illustrated in FIGS. 24A and 24B. When the type of binding that is instructed by the post-processing command is the “oblique binding,” in step S801, the controller 100 also drives the crimper pivot motor 239 to rotate the crimper 32′ from the standby angle to a binding angle corresponding to the “oblique binding posture.” It is ascertained based on a pulse signal output from a rotary encoder of the crimper movement motor 238 that the crimper 32′ has reached the position where the crimper 32′ can face the binding position B5. Similarly, it is ascertained based on a pulse signal output from a rotary encoder of the crimper pivot motor 239 that the crimper 32′ has reached the binding angle. When the type of binding that is instructed by the post-processing command is the “parallel binding,” the controller 100 omits the aforementioned operation of rotating the crimper 32′. In other words, the crimper 32′ moves in the main scanning direction while maintaining the standby angle.

Subsequently, in step S802, the controller 100 drives the conveyance roller pairs 10 and 11 to start conveying the sheet P on which an image is formed by the image forming apparatus 2. The controller 100 continues driving the conveyance roller pairs 10 and 11 until the liquid application position B5 on the sheet P faces the liquid application unit 140 (more particularly, the liquid application head 146) (S803: No). When the liquid application position B5 on the sheet P has faced the liquid application head 146 (YES in step S803), in step S804, the controller 100 stops the conveyance roller pairs 10 and 11. It is ascertained based on a pulse signal output from a rotary encoder of a motor that drives the conveyance roller pairs 10 and 11 that the liquid application position B5 on the sheet P has faced the liquid application head 146.

In step S805, the controller 100 causes the liquid application unit 140 to execute the process to apply liquid to the liquid application position B5 on the sheet P. More specifically, the controller 100 rotates the application head movement motor 151 in the first direction to bring the liquid application head 146 into contact with the liquid application position B5 on the sheet P. The controller 100 changes the pressing force of the liquid application head 146 (in other words, the amount of rotation of the application head movement motor 151) depending on the amount of liquid to be applied to the sheet P.

The amount of liquid that is applied to the sheet P may be the same for all the sheets P of the sheet bundle Pb or may be different for each sheet P. For example, the controller 100 may apply a decreased amount of liquid to the sheet P conveyed later. The amount of rotation of the application head movement motor 151 may be ascertained based on a pulse signal output from a rotary encoder of the application head movement motor 151.

In step S806, the controller 100 drives the conveyance roller pairs 10, 11, 14, and 15 to place the sheet P on the internal tray 22. Furthermore, the controller 100 aligns the positions of the ends in the main scanning direction of the sheet P or the sheet bundle Pb stacked on the internal tray 22 by moving the side fences 24L and 24R to the opposing direction (so-called jogging process) (S806).

Subsequently, in step S807, the controller 100 determines whether the number of sheets P placed on the internal tray 22 has reached the given number N instructed by the post-processing command. When the controller 100 determines that the number of sheets P placed on the internal tray 22 has not reached the given number N (NO in step S807), the controller 100 executes the operations of steps S802 to S806 again.

When the controller 100 determines that the number of sheets P placed on the internal tray 22 has reached the given number N (YES in step S807), in step S808, the controller 100 causes the crimper 32′ to crimp and bind the binding position B5 (corresponding to the liquid application position B5) on the sheet bundle Pb to which the liquid has been applied by the liquid application unit 140. In step S808, the controller 100 also rotates the conveyance roller pair 15 to output the sheet bundle Pb thus crimped and bound to the second output tray 26.

Then, the controller 100 drives the liquid applier movement motor 137 to move the liquid application unit 140 to the standby position HP3 and drives the crimper movement motor 238 to move the crimper 32′ to the standby position HP3.

When the post-processing command includes an instruction to form a plurality of sheet bundles Pb (i.e., the requested number of copies M), the controller 100 determines whether the number of sheet bundles Pb output to the second output tray 26 has reached the requested number of copies M as in step S908 in FIG. 14. When the controller 100 determines that the number of sheet bundles Pb output to the second output tray 26 has not reached the requested number of copies M, the controller 100 repeats the operations of steps S802 to S808. When the controller 100 determines that the number of sheet bundles Pb output to the second output tray 26 has reached the requested number of copies M, the controller 100 moves the liquid application unit 140 and the crimper 32′ to the standby position HP3 as described above.

The embodiments of the present disclosure are applied to the edge binder 25 that executes the edge binding as described above. However, the embodiments of the present disclosure may be applied to the saddle binder 28 that executes the saddle binding.

As described above, the present embodiment relates to a medium processing apparatus including a mechanism that can execute crimp binding process involving liquid application, and includes a rust adhesion prevention mode for adhering residual moisture to a sheet in order to appropriately remove moisture adhering to the crimper. By executing the operation in the rust adhesion prevention mode, it is possible to prevent the occurrence of rust on the crimping teeth due to residual moisture, and even when rust occurs, it is possible to attach and remove the rust on the sheet. As a result, it is possible to prevent rust from adhering to the bundle of sheets which is the printed matter desired by the user.

The control method described above may be implemented by, for example, a program. In other words, the control method may be executed by causing an arithmetic device, a storage device, an input device, an output device, and a control device to operate in cooperation with each other based on a program. In addition, the program may be written in, for example, a storage device or a storage medium and distributed, or may be distributed through, for example, an electric communication line.

The present disclosure is not limited to specific embodiments described above, and numerous additional modifications and variations are possible in light of the teachings within the technical scope of the appended claims. The above-described embodiments and modifications are some examples, and various modifications and variations can be practiced from such examples by those skilled in the art. Such embodiments and variations thereof are included in the scope and gist of the embodiments of the present disclosure and are included in the embodiments described in claims and the equivalent scope thereof.

A description is now given below of several aspects of the present disclosure.

### Aspect 1

In Aspect 1, a medium processing apparatus includes a liquid applier, a medium processing device, and a control unit. The liquid applier includes a liquid application member that performs liquid application on a part of at least one medium. The medium processing device executes a binding process on a media bundle including the at least one medium on which the liquid application has been performed or the at least one medium. The control unit controls operations of the liquid applier and the medium processing device according to an operation mode. The control unit includes a liquid application binding mode and a rust adhesion prevention mode. In the liquid application binding mode, the medium processing device executes the binding process on the media bundle including the at least one medium on which the liquid application has been performed. In the rust adhesion prevention mode, the binding process is executed on the at least one medium without performing the liquid application.

### Aspect 2

In Aspect 2, in the medium processing apparatus according to Aspect 1, the medium processing device includes a crimper that presses and deforms a part of the medium or the media bundle as the binding process. The control unit is further to perform the pressure deformation on the at least one medium in the rust adhesion prevention mode.

### Aspect 3

In Aspect 3, in the medium processing apparatus of Aspect 1 or Aspect 2, the control unit sets a discharge destination of the media bundle that is a target of the binding process in the binding mode, and a discharge destination of the medium that is a target of the binding process in the rust adhesion prevention mode, as different discharge destinations.

### Aspect 4

In Aspect 4, the medium processing apparatus of any one of Aspects 1 to 3 includes a separation assembly that separates the at least one medium from the media bundle bound by the medium processing device.

### Aspect 5

In Aspect 5, the medium processing apparatus of any one of Aspects 1 to 4 includes an operation selector that enables a user to select an operation mode, in which the control unit switches the operation mode from the binding mode to the rust adhesion prevention mode in response to designation by the user via the operation selector.

### Aspect 6

In Aspect 6, in the medium processing apparatus of Aspect 5, the control unit automatically switches the operation mode from the binding mode to the rust adhesion prevention mode according to a user's designation via the operation selector.

### Aspect 7

In Aspect 7, in the medium processing apparatus of Aspect 6, when the switching of the operation mode to the rust adhesion prevention mode is set to be automatic, the control unit controls the medium processing device to perform a rust adhesion prevention following the liquid application by the liquid applier.

### Aspect 8

In Aspect 8, in the medium processing apparatus of Aspect 5, the operation mode is manually switchable to the rust adhesion prevention mode by the user via the operation selector.

### Aspect 9

In Aspect 9, in the medium processing apparatus of any one of Aspects 5 to 8, the control unit enables setting of a number of repetitions of the binding process in the rust adhesion prevention mode via the operation selector.

### Aspect 10

In Aspect 10, an image forming system includes an image forming apparatus that forms an image on a medium, and the medium processing apparatus of any one of Aspects 1 to 7.

### Aspect 11

In Aspect 11, a medium processing apparatus includes a liquid applier, a post-processing device, and circuitry. The liquid applier performs liquid application on a medium. The post-processing device performs a binding process on a media bundle including the medium subjected to the liquid application by the liquid applier, or a medium not subjected to the liquid application. The circuitry is to control operations of the liquid applier and the post-processing device according to operation modes. The operation modes of the post-processing device include a first mode to perform the binding process on the media bundle including the medium on which the liquid application is performed, and a second mode to perform the binding process on the medium on which the liquid application is not performed.

### Aspect 12

In Aspect 12, in the medium processing apparatus according to Aspect 11, the post-processing device includes a crimper to press and deform a part of the medium or a part of the media bundle to perform the binding process. The circuitry is further to control the crimper to press and deform the part of the medium in the second mode.

### Aspect 13

In Aspect 13, in the medium processing apparatus according to Aspect 11 or 12, the circuitry is further to control the post-processing device to eject the media bundle subjected to the binding process in the first mode to a first stacker, and eject the medium subjected to the binding process in the second mode to a second stacker different from the first stacker.

### Aspect 14

In Aspect 14, the medium processing apparatus according to any one of Aspects 11 to 13 further includes a separation assembly to separate the media bundle bound by the post-processing device from the post-processing device, or separate the medium from the post-processing device.

### Aspect 15

In Aspect 15, the medium processing apparatus according to any one of Aspects 11 to 14 further includes an operation selector configured to select the operation modes. The circuitry is further to change the operation modes from the first mode to the second mode in response to a selection selected via the operation selector.

### Aspect 16

In Aspect 16, in the medium processing apparatus according to Aspect 15, the circuitry is further to automatically change the operation modes from the first mode to the second mode in response to the selection selected via the operation selector.

### Aspect 17

In Aspect 17, in the medium processing apparatus according to Aspect 16, the circuitry is further to control the post-processing device to perform the second mode after controlling the liquid applier to perform the liquid application.

### Aspect 18

In Aspect 18, in the medium processing apparatus according to Aspect 15, the circuitry is further to change the operation modes from the first mode to the second mode in response to the selection manually selected via the operation selector.

### Aspect 19

In Aspect 19, in the medium processing apparatus according to any one of Aspects 15 to 18, the operation selector is configured to set a number of repetitions of the binding process in the second mode.

### Aspect 20

In Aspect 20, an image forming system includes an image forming apparatus to form an image on a medium, and the medium processing apparatus according to any one of Aspect 11 to 17.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a liquid applier to perform liquid application on a medium;
a post-processing device to perform a binding process on:
a media bundle including the medium subjected to the liquid application by the liquid applier; or
a medium not subjected to the liquid application; and
circuitry configured to control operations of the liquid applier and the post-processing device according to operation modes,
wherein the operation modes of the post-processing device include:
a first mode to perform the binding process on the media bundle including the medium on which the liquid application is performed; and
a second mode to perform the binding process on the medium on which the liquid application is not performed.

2. The medium processing apparatus according to claim 1,
wherein the post-processing device includes a crimper to press and deform a part of the medium or a part of the media bundle to perform the binding process, and
the circuitry is further configured to control the crimper to press and deform the part of the medium in the second mode.

3. The medium processing apparatus according to claim 1,
wherein the circuitry is further configured to control the post-processing device to:
eject the media bundle subjected to the binding process in the first mode to a first stacker; and
eject the medium subjected to the binding process in the second mode to a second stacker different from the first stacker.

4. The medium processing apparatus according to claim 1, further comprising a separation assembly to:
separate the media bundle bound by the post-processing device from the post-processing device; or
separate the medium from the post-processing device.

5. The medium processing apparatus according to claim 1, further comprising an operation selector configured to select the operation modes,
wherein the circuitry is further configured to change the operation modes from the first mode to the second mode in response to a selection selected via the operation selector.

6. The medium processing apparatus according to claim 5,
wherein the circuitry is further configured to automatically change the operation modes from the first mode to the second mode in response to the selection selected via the operation selector.

7. The medium processing apparatus according to claim 6,
wherein the circuitry is further configured to control the post-processing device to perform the second mode after controlling the liquid applier to perform the liquid application.

8. The medium processing apparatus according to claim 5,
wherein the circuitry is further configured to change the operation modes from the first mode to the second mode in response to the selection manually selected via the operation selector.

9. The medium processing apparatus according to claim 5,
wherein the operation selector is configured to set a number of repetitions of the binding process in the second mode.

10. An image forming system comprising:
an image forming apparatus to form an image on a medium; and
the medium processing apparatus according to claim 1.
